(19) United States
(12) Patent Application Publication
(10) Pub. No.: US 2025/0216555 A1
(43) Pub. Date: Jul. 3, 2025

(54) LIDAR Odometry for Localization

(71) Applicant: Aurora Operations, Inc., Pittsburgh, PA (US)

(72) Inventors: James Scott Jackson, Fruit Heights, UT (US); Mikhail Smirnov, Bellevue, WA (US)

(21) Appl. No.: 18/399,982

(22) Filed: Dec. 29, 2023

(51) Int. Cl. G01S 17/931; G01S 17/58

(52) U.S. Cl. CPC G01S 17/931; G01S 17/58

(57) ABSTRACT

A localization system can obtain a LIDAR observation oriented relative to a vehicle frame, the vehicle frame oriented with respect to a pose of a vehicle; access a local environment map descriptive of the environment of the vehicle, wherein the local environment map is oriented relative to a keyframe at a given time, the local environment map including a plurality of surfels and generated in real-time during a current operational instance of the vehicle based on one or more prior LIDAR observations captured during the current operational instance of the vehicle; determine a transform between the vehicle frame and the keyframe by aligning the LIDAR observation to the local environment map based on a similarity between the LIDAR observation and the local environment map; and determine an updated pose of the vehicle based on the transform and the pose of the vehicle in the vehicle frame at the given.

### BACKGROUND

An autonomous platform can process data to perceive an environment through which the autonomous platform travels. For example, an autonomous vehicle can perceive its environment using a variety of sensors and identify objects around the autonomous vehicle. The autonomous vehicle can identify an appropriate path through the perceived surrounding environment and navigate along the path with minimal or no human input.

### SUMMARY

An autonomous vehicle, such as an autonomous vehicle towing a trailer (e.g., an autonomous truck) can navigate through the use of a pose estimation system. Autonomous vehicles can desirably localize themselves with respect to their environment. Autonomous vehicle control system(s) (e.g., located at least partially onboard an autonomous vehicle) can receive inputs that facilitate localization of the autonomous vehicle relative to a local or global reference. For instance, the autonomous vehicle control system can capture sensor data from sensors observing the environment of the autonomous vehicle. The autonomous vehicle control system can also receive map data indicative of known terrain, structures, etc., motion data from an inertial measurement unit (IMU) onboard the vehicle, wheel rotation data from wheel encoders, or other suitable inputs. These inputs can be highly reliable. However, it can be desirable to safeguard against occasional sensor input error, especially over a high-mileage operating lifetime of an autonomous vehicle.

The present disclosure is directed to systems and methods for localizing an autonomous vehicle. In particular, a LIDAR odometry system can generate, in real-time, a local environment map of a vehicle's environment generated from recent LIDAR observations. The map can be oriented with respect to a keyframe corresponding to the vehicle's pose at some recent, prior point in time. The local environment map can be initially generated from prior LIDAR observation(s) and can be progressively updated, in real-time, with data from new LIDAR observations as the vehicle traverses its environment. The LIDAR odometry system can refresh the local environment map by establishing a new keyframe at the vehicle's current pose, translating the data from the prior local environment map such that the prior data is oriented relative to the new keyframe instead of the prior keyframe. New LIDAR observations can then be applied to update the translated data at the new keyframe.

The LIDAR odometry system can generate a pose estimate for the vehicle by aligning a current LIDAR observation, oriented with respect to a vehicle frame, to the local environment map. For instance, the LIDAR observation can include a plurality of LIDAR points, and the local environment map can include a plurality of surfels. The LIDAR odometry system can control for (e.g., minimize) the total or average distance between the LIDAR points and corresponding surfels to determine a transform between the vehicle frame and the keyframe of the local environment map. The transform can best match the LIDAR observation data to what is known of the environment based on the local environment map. Furthermore, the pose estimate of the vehicle in the keyframe can be determined by applying the transform to the pose of the vehicle in the vehicle frame (e.g., the origin of the vehicle frame). In this manner, the LIDAR odometry system can produce accurate pose estimates of the vehicle in real-time that accounts for the most current available state of the vehicle's surroundings.

Systems and methods according to example aspects of the present disclosure can provide for a number of technical effects and benefits. As one example, systems and methods according to example aspects of the present disclosure can provide for improved accuracy of pose estimates for localizing an autonomous vehicle. In particular, the LIDAR odometry systems can provide pose estimates based on LIDAR data that corresponds to a current state of an environment in real-time, as observed by a vehicle or platform, rather than stored map data that may not represent a current state of an environment. Furthermore, the LIDAR odometry systems can provide pose estimates with extremely precise relation to surrounding environments. In this way, an autonomous vehicle can better orient itself within its surroundings, providing an increased level of confidence in its onboard operations.

The technology of the present disclosure also provides significant technical computing improvements to the overall autonomy functions of the autonomous vehicle. For instance, by improving the accuracy of its localization outputs using the LIDAR odometry techniques described herein, the autonomous vehicle's perception functions can also be improved. For example, the autonomous vehicle can better understand its position relative to objects within its environment, including lane markings. This can also allow for more precise motion planning. By increasing computational confidence with improved localization, the autonomous vehicle can increase its processing efficiency, while decreasing overall onboard computing latency.

For example, in an aspect, the present disclosure provides a computer-implemented method. The method includes obtaining a LIDAR observation oriented relative to a vehicle frame, wherein the vehicle frame is oriented with respect to a pose of a vehicle at a given time. The method includes accessing a local environment map descriptive of the environment of the vehicle, the local environment map oriented relative to a keyframe, the local environment map including a plurality of surfels. The local environment map is generated in real-time during a current operational instance of the vehicle based on one or more prior LIDAR observations captured during the current operational instance of the vehicle. The method includes determining a transform between the vehicle frame and the keyframe by aligning the LIDAR observation to the local environment map based on a similarity between the LIDAR observation and the local environment map. The method includes determining an updated pose of the vehicle based on the transform and the pose of the vehicle in the vehicle frame.

In some implementations, the updated pose of the vehicle is oriented relative to the keyframe.

In some implementations, a surfel of the plurality of surfels includes a disc, the disc defined by a position vector a normal vector, and a radius.

In some implementations, determining the transform between the vehicle frame and the keyframe includes aligning the LIDAR observation to the plurality of surfels of the local environment map to minimize an aggregate distance between the LIDAR observation and the plurality of surfels.

In some implementations, the LIDAR observation includes a LIDAR point cloud, the LIDAR point cloud having a plurality of LIDAR points.

In some implementations, minimizing the aggregate distance between the LIDAR observation and the plurality of surfels includes minimizing the aggregate distance between each LIDAR point in the LIDAR point cloud of the LIDAR observation and the normal vector of a corresponding surfel of the plurality of surfels.

In some implementations, minimizing the aggregate distance between the LIDAR observation and the plurality of surfels includes minimizing an average distance between each LIDAR point in the LIDAR point cloud and the normal vector of a corresponding surfel of the plurality of surfels.

In some implementations, aligning the LIDAR observation to the plurality of surfels is performed over a fixed number of iterations, and wherein the pose estimate of the vehicle includes a null output if the aggregate distance between the LIDAR observation and the plurality of surfels is not resolved over the fixed number of iterations.

In some implementations, the method further includes masking one or more actor regions in the LIDAR observation, wherein the one or more actor regions include data associated with a moving object.

In some implementations, masking the one or more actor regions includes omitting the one or more actor regions from the LIDAR observations when determining a transform between the vehicle frame and the keyframe by aligning the LIDAR observation to the local environment map.

In some implementations, determining the updated pose includes applying the transform to the pose of the vehicle in the vehicle frame to determine the updated pose of the vehicle.

In some implementations, the LIDAR observation is captured relative to the pose of the vehicle in the vehicle frame.

In some implementations, the method further includes determining a motion trajectory for the vehicle based on the updated pose of the vehicle. In some implementations, the method further includes controlling the vehicle based on the motion trajectory.

For example, in an aspect, the present disclosure provides an autonomous vehicle control system. The autonomous vehicle control system includes one or more processors and one or more non-transitory, computer-readable media storing instructions that cause the one or more processors to perform operations. The operations include obtaining a LIDAR observation oriented relative to a vehicle frame, wherein the vehicle frame is oriented with respect to a pose of a vehicle at a given time. The operations include accessing a local environment map descriptive of the environment of the vehicle, the local environment map oriented relative to a keyframe, the local environment map including a plurality of surfels. The local environment map is generated in real-time during a current operational instance of the vehicle based on one or more prior LIDAR observations captured during the current operational instance of the vehicle. The operations include determining a transform between the vehicle frame and the keyframe by aligning the LIDAR observation to the local environment map based on a similarity between the LIDAR observation and the local environment map. The operations include determining an updated pose of the vehicle based on the transform and the pose of the vehicle in the vehicle frame at the given time.

In some implementations, the updated pose of the vehicle includes a transformed pose, the transformed pose oriented relative to the keyframe.

In some implementations, determining the transform between the vehicle frame and the keyframe includes aligning the LIDAR observation to the plurality of surfels of the local environment map to minimize an aggregate distance between the LIDAR observation and the plurality of surfels.

In some implementations, the LIDAR observation includes a LIDAR point cloud, the LIDAR point cloud having one or more LIDAR points.

In some implementations, minimizing the aggregate distance between the LIDAR observation and the plurality of surfels includes minimizing the aggregate distance between each LIDAR point in the LIDAR point cloud of the LIDAR observation and a corresponding surfel of the plurality of surfels.

In some implementations, minimizing the aggregate distance between the LIDAR observation and the plurality of surfels includes minimizing an average distance between each LIDAR point in the LIDAR point cloud and a corresponding surfel of the plurality of surfels.

For example, in an aspect, the present disclosure provides an autonomous vehicle. The autonomous vehicle includes one or more processors and one or more non-transitory, computer-readable media storing instructions that cause the one or more processors to perform operations. The operations include obtaining a LIDAR observation oriented relative to a vehicle frame, the vehicle frame oriented with respect to a pose of a vehicle. The operations include accessing a local environment map descriptive of the environment of the vehicle, wherein the local environment map is oriented relative to a keyframe at a given time, the local environment map including a plurality of surfels. The local environment map is generated in real-time during a current operational instance of the vehicle based on one or more prior LIDAR observations captured during the current operational instance of the vehicle. The operations include determining a transform between the vehicle frame and the keyframe by aligning the LIDAR observation to the local environment map based on a similarity between the LIDAR observation and the local environment map. The operations include determining an updated pose of the vehicle based on the transform and the pose of the vehicle in the vehicle frame at the given.

For example, in an aspect, the present disclosure provides a computer-implemented method. The method includes obtaining a first local environment map descriptive of an environment of a vehicle, the first local environment map oriented relative to a first keyframe, the first keyframe having an origin associated with a previous pose of the vehicle. The method includes obtaining a LIDAR observation, the LIDAR observation associated with a current pose of the vehicle. The method includes determining that the current pose of the vehicle differs from the previous pose of the vehicle by greater than a threshold distance. The method includes, in response to determining that the current pose of the vehicle differs from the previous pose of the vehicle by greater than a threshold distance, generating a second keyframe oriented relative to the current pose of the vehicle. The method includes transforming the first local environment map to the second keyframe to generate a second local environment map. The method includes updating the second local environment map based on the LIDAR observation.

In some implementations, the first local environment map includes a surfel map, the surfel map including a plurality of surfels.

In some implementations, a surfel of the plurality of surfels includes a disc, the disc defined by a position vector, a normal vector, and a radius.

In some implementations, the LIDAR observation includes a LIDAR point cloud, the LIDAR point cloud having a plurality of LIDAR points.

In some implementations, updating the second local environment map includes masking one or more actor regions in the LIDAR observation, wherein the one or more actor regions include data associated with a moving object.

In some implementations, determining that the current pose of the vehicle differs from the previous pose of the vehicle by greater than a threshold distance includes determining that the vehicle has traveled a distance greater than the threshold distance from the previous pose of the vehicle.

In some implementations, the first keyframe and the second keyframe do not have a common heading.

In some implementations, transforming the first local environment map to the second keyframe to generate the second local environment map includes transforming data in the first local environment map to the second keyframe to generate the second local environment map.

In some implementations, transforming data in the first local environment map to the second keyframe includes: determining a transformation between the first keyframe and a first map frame associated with the first keyframe; determining a transformation between the first map frame associated with the first keyframe and the first local environment map and a second map frame associated with the second keyframe; and determining a transformation between the second map frame and the second keyframe.

In some implementations, the method further includes pruning data greater than a cutoff distance from the current pose of the vehicle from the second local environment map.

In some implementations, obtaining the first local environment map includes producing the first local environment map using one or more prior LIDAR observations.

Other example aspects of the present disclosure are directed to other systems, methods, vehicles, apparatuses, tangible non-transitory computer-readable media, and devices for localizing an autonomous vehicle.

These and other features, aspects and advantages of various implementations of the present disclosure will become better understood with reference to the following description and appended claims. The accompanying drawings, which are incorporated in and constitute a part of this specification, illustrate embodiments of the present disclosure and, together with the description, serve to explain the related principles.

### BRIEF DESCRIPTION OF THE DRAWINGS

FIG. 1 is a block diagram of an example operational scenario, according to some implementations of the present disclosure;

FIG. 2 is a block diagram of an example system, according to some implementations of the present disclosure;

FIG. 3A is a representation of an example operational environment, according to some implementations of the present disclosure;

FIG. 3B is a representation of an example map of an operational environment, according to some implementations of the present disclosure;

FIG. 3C is a representation of an example operational environment, according to some implementations of the present disclosure;

FIG. 3D is a representation of an example map of an operational environment, according to some implementations of the present disclosure;

FIG. 4 is a diagram of an example LIDAR observation annotated with information about actors according to some implementations of the present disclosure;

FIG. 5 is a block diagram of an example portion of a vehicle control system, according to some implementations of the present disclosure;

FIG. 6 is a block diagram of an example portion of an autonomous vehicle control system, according to some implementations of the present disclosure;

FIG. 7 is a flowchart of an example method for localizing an autonomous vehicle, according to some implementations of the present disclosure;

FIG. 8 is a flowchart of an example method for localizing an autonomous vehicle, according to some implementations of the present disclosure; and

FIG. 9 is a block diagram of an example computing system for localizing an autonomous vehicle, according to some implementations of the present disclosure.

### DETAILED DESCRIPTION

The following describes the technology of this disclosure within the context of an autonomous vehicle for example purposes only. As described herein, the technology described herein is not limited to an autonomous vehicle and can be implemented for or within other autonomous platforms and other computing systems. As used herein, “about” in conjunction with a stated numerical value is intended to refer to within 20 percent of the stated numerical value, except where otherwise indicated.

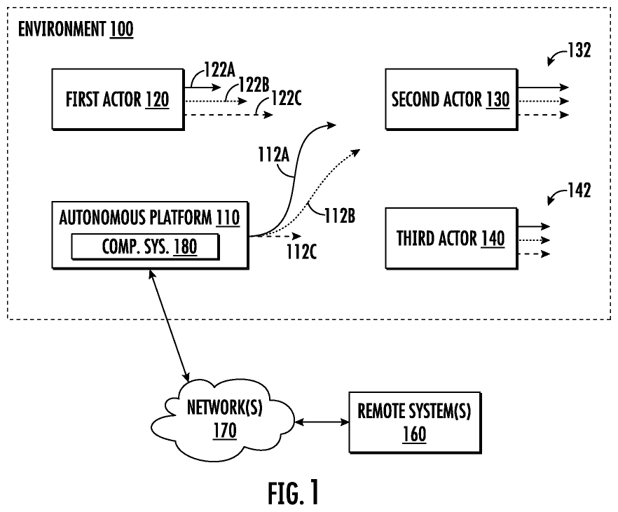

With reference to FIGS. 1-9, example embodiments of the present disclosure are discussed in further detail. FIG. 1 is a block diagram of an example operational scenario according to example implementations of the present disclosure. In the example operational scenario, an environment 100 contains an autonomous platform 110 and a number of objects, including first actor 120, second actor 130, and third actor 140. In the example operational scenario, the autonomous platform 110 can move through the environment 100 and interact with the object(s) that are located within the environment 100 (e.g., first actor 120, second actor 130, third actor 140, etc.). The autonomous platform 110 can optionally be configured to communicate with remote system(s) 160 through network(s) 170.

The environment 100 can be or include an indoor environment (e.g., within one or more facilities, etc.) or an outdoor environment. An indoor environment, for example, can be an environment enclosed by a structure such as a building (e.g., a service depot, maintenance location, manufacturing facility, etc.). An outdoor environment, for example, can be one or more areas in the outside world such as, for example, one or more rural areas (e.g., with one or more rural travel ways, etc.), one or more urban areas (e.g., with one or more city travel ways, highways, etc.), one or more suburban areas (e.g., with one or more suburban travel ways, etc.), or other outdoor environments.

The autonomous platform 110 can be any type of platform configured to operate within the environment 100. For example, the autonomous platform 110 can be a vehicle configured to autonomously perceive and operate within the environment 100. The vehicles can be a ground-based autonomous vehicle such as, for example, an autonomous car, truck, van, etc. The autonomous platform 110 can be an autonomous vehicle that can control, be connected to, or be otherwise associated with implements, attachments, or accessories for transporting people or cargo. This can include, for example, an autonomous tractor optionally coupled to a cargo trailer. Additionally or alternatively, the autonomous platform 110 can be any other type of vehicle such as one or more aerial vehicles, water-based vehicles, space-based vehicles, other ground-based vehicles, etc.

The autonomous platform 110 can be configured to communicate with the remote system(s) 160. For instance, the remote system(s) 160 can communicate with the autonomous platform 110 for assistance (e.g., navigation assistance, situation response assistance, etc.), control (e.g., fleet management, remote operation, etc.), maintenance (e.g., updates, monitoring, etc.), or other local or remote tasks. In some implementations, the remote system(s) 160 can provide data indicating tasks that the autonomous platform 110 should perform. For example, as further described herein, the remote system(s) 160 can provide data indicating that the autonomous platform 110 is to perform a trip/service such as a user transportation trip/service, delivery trip/service (e.g., for cargo, freight, items), etc.

The autonomous platform 110 can communicate with the remote system(s) 160 using the network(s) 170. The network(s) 170 can facilitate the transmission of signals (e.g., electronic signals, etc.) or data (e.g., data from a computing device, etc.) and can include any combination of various wired (e.g., twisted pair cable, etc.) or wireless communication mechanisms (e.g., cellular, wireless, satellite, microwave, radio frequency, etc.) or any desired network topology (or topologies). For example, the network(s) 170 can include a local area network (e.g., intranet, etc.), a wide area network (e.g., the Internet, etc.), a wireless LAN network (e.g., through Wi-Fi, etc.), a cellular network, a SATCOM network, a VHF network, a HF network, a WiMAX based network, or any other suitable communications network (or combination thereof) for transmitting data to or from the autonomous platform 110.

As shown for example in FIG. 1, the environment 100 can include one or more objects. The object(s) can be objects not in motion or not predicted to move (“static objects”) or object(s) in motion or predicted to be in motion (“dynamic objects” or “actors”). In some implementations, the environment 100 can include any number of actor(s) such as, for example, one or more pedestrians, animals, vehicles, etc. The actor(s) can move within the environment according to one or more actor trajectories. For instance, the first actor 120 can move along any one of the first actor trajectories 122A-C, the second actor 130 can move along any one of the second actor trajectories 132, the third actor 140 can move along any one of the third actor trajectories 142, etc.

As further described herein, the autonomous platform 110 can utilize its autonomy system(s) to detect these actors (and their movement) and plan its motion to navigate through the environment 100 according to one or more platform trajectories 112A-C. The autonomous platform 110 can include onboard computing system(s) 180. The onboard computing system(s) 180 can include one or more processors and one or more memory devices. The one or more memory devices can store instructions executable by the one or more processors to cause the one or more processors to perform operations or functions associated with the autonomous platform 110, including implementing its autonomy system(s). In particular, according to example aspects of the present disclosure, the autonomous platform 110 can localize itself with respect to the environment 100 or with respect to the object(s) in the environment 100.

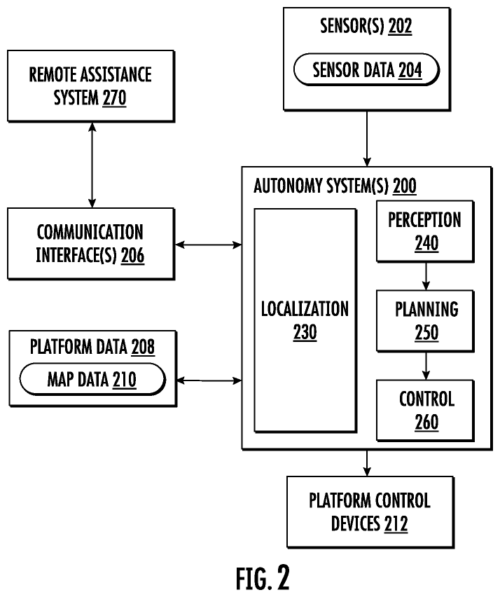

FIG. 2 is a block diagram of an example autonomy system 200 for an autonomous platform, according to some implementations of the present disclosure. In some implementations, the autonomy system 200 can be implemented by a computing system of the autonomous platform (e.g., the onboard computing system(s) 180 of the autonomous platform 110). The autonomy system 200 can operate to obtain inputs from sensor(s) 202 or other input devices. In some implementations, the autonomy system 200 can additionally obtain platform data 208 (e.g., map data 210) from local or remote storage. The autonomy system 200 can generate control outputs for controlling the autonomous platform (e.g., through platform control devices 212, etc.) based on sensor data 204, map data 210, or other data. The autonomy system 200 can include different subsystems for performing various autonomy operations. The subsystems can include a localization system 230, a perception system 240, a planning system 250, and a control system 260. The localization system 230 can determine the location of the autonomous platform within its environment; the perception system 240 can detect, classify, and track objects and actors in the environment; the planning system 250 can determine a trajectory for the autonomous platform; and the control system 260 can translate the trajectory into vehicle controls for controlling the autonomous platform. The autonomy system 200 can be implemented by one or more onboard computing system(s). The subsystems can include one or more processors and one or more memory devices. The one or more memory devices can store instructions executable by the one or more processors to cause the one or more processors to perform operations or functions associated with the subsystems. The computing resources of the autonomy system 200 can be shared among its subsystems, or a subsystem can have a set of dedicated computing resources.

In some implementations, the autonomy system 200 can be implemented for or by an autonomous vehicle (e.g., a ground-based autonomous vehicle). The autonomy system 200 can perform various processing techniques on inputs (e.g., the sensor data 204, the map data 210) to perceive and understand the vehicle's surrounding environment and generate an appropriate set of control outputs to implement a vehicle motion plan (e.g., including one or more trajectories) for traversing the vehicle's surrounding environment (e.g., environment 100 of FIG. 1, etc.). In some implementations, an autonomous vehicle implementing the autonomy system 200 can drive, navigate, operate, etc. with minimal or no interaction from a human operator (e.g., driver, pilot, etc.).

In some implementations, the autonomous platform can be configured to operate in a plurality of operating modes. For instance, the autonomous platform can be configured to operate in a fully autonomous (e.g., self-driving, etc.) operating mode in which the autonomous platform is controllable without user input (e.g., can drive and navigate with no input from a human operator present in the autonomous vehicle or remote from the autonomous vehicle, etc.). The autonomous platform can operate in a semi-autonomous operating mode in which the autonomous platform can operate with some input from a human operator present in the autonomous platform (or a human operator that is remote from the autonomous platform). In some implementations, the autonomous platform can enter into a manual operating mode in which the autonomous platform is fully controllable by a human operator (e.g., human driver, etc.) and can be prohibited or disabled (e.g., temporary, permanently, etc.) from performing autonomous navigation (e.g., autonomous driving, etc.). The autonomous platform can be configured to operate in other modes such as, for example, park or sleep modes (e.g., for use between tasks such as waiting to provide a trip/service, recharging, etc.). In some implementations, the autonomous platform can implement vehicle operating assistance technology (e.g., collision mitigation system, power assist steering, etc.), for example, to help assist the human operator of the autonomous platform (e.g., while in a manual mode, etc.).

The autonomy system 200 can be located onboard (e.g., on or within) an autonomous platform and can be configured to operate the autonomous platform in various environments. The environment can be a real-world environment or a simulated environment. In some implementations, one or more simulation computing devices can simulate one or more of: the sensors 202, the sensor data 204, communication interface(s) 206, the platform data 208, or the platform control devices 212 for simulating operation of the autonomy system 200.

In some implementations, the autonomy system 200 can communicate with one or more networks or other systems with the communication interface(s) 206. The communication interface(s) 206 can include any suitable components for interfacing with one or more network(s) (e.g., the network(s) 170 of FIG. 1, etc.), including, for example, transmitters, receivers, ports, controllers, antennas, or other suitable components that can help facilitate communication. In some implementations, the communication interface(s) 206 can include a plurality of components (e.g., antennas, transmitters, or receivers, etc.) that allow it to implement and utilize various communication techniques (e.g., multiple-input, multiple-output (MIMO) technology, etc.).

In some implementations, the autonomy system 200 can use the communication interface(s) 206 to communicate with one or more computing devices that are remote from the autonomous platform (e.g., the remote system(s) 160) over one or more network(s) (e.g., the network(s) 170). For instance, in some examples, one or more inputs, data, or functionalities of the autonomy system 200 can be supplemented or substituted by a remote system communicating over the communication interface(s) 206. For instance, in some implementations, the map data 210 can be downloaded over a network to a remote system using the communication interface(s) 206. In some examples, one or more of the localization system 230, the perception system 240, the planning system 250, or the control system 260 can be updated, influenced, nudged, communicated with, etc. by a remote system for assistance, maintenance, situational response override, management, etc.

The sensor(s) 202 can be located onboard the autonomous platform. In some implementations, the sensor(s) 202 can include one or more types of sensor(s). For instance, one or more sensors can include image capturing device(s) (e.g., visible spectrum cameras, infrared cameras, etc.). Additionally or alternatively, the sensor(s) 202 can include one or more depth capturing device(s). For example, the sensor(s) 202 can include one or more Light Detection and Ranging (LIDAR) sensor(s) or Radio Detection and Ranging (RADAR) sensor(s). The sensor(s) 202 can be configured to generate point data descriptive of at least a portion of a three-hundred-and-sixty-degree view of the surrounding environment. The point data can be point cloud data (e.g., three-dimensional LIDAR point cloud data, RADAR point cloud data). In some implementations, one or more of the sensor(s) 202 for capturing depth information can be fixed to a rotational device in order to rotate the sensor(s) 202 about an axis. The sensor(s) 202 can be rotated about the axis while capturing data in interval sector packets descriptive of different portions of a three-hundred-and-sixty-degree view of a surrounding environment of the autonomous platform. In some implementations, one or more of the sensor(s) 202 for capturing depth information can be solid state.

The sensor(s) 202 can be configured to capture the sensor data 204 indicating or otherwise being associated with at least a portion of the environment of the autonomous platform. The sensor data 204 can include image data (e.g., 2D camera data, video data, etc.), RADAR data, LIDAR data (e.g., 3D point cloud data, etc.), audio data, or other types of data. In some implementations, the autonomy system 200 can obtain input from additional types of sensors 202, such as inertial measurement units (IMUs), altimeters, inclinometers, odometry devices, location or positioning devices (e.g., GPS, compass), wheel encoders, or other types of sensors. In some implementations, the autonomy system 200 can obtain sensor data 204 associated with particular component(s) or system(s) of an autonomous platform. This sensor data 204 can indicate, for example, wheel speed, component temperatures, steering angle, cargo or passenger status, etc. In some implementations, the autonomy system 200 can obtain sensor data 204 associated with ambient conditions, such as environmental or weather conditions. In some implementations, the sensor data 204 can include multi-modal sensor data. The multi-modal sensor data can be obtained by at least two different types of sensor(s) (e.g., of the sensors 202) and can indicate static object(s) or actor(s) within an environment of the autonomous platform. The multi-modal sensor data can include at least two types of sensor data (e.g., camera and LIDAR data). In some implementations, the autonomous platform can utilize the sensor data 204 for sensors that are remote from (e.g., offboard) the autonomous platform. This can include for example, sensor data 204 captured by a different autonomous platform.

The autonomy system 200 can obtain the map data 210 associated with an environment in which the autonomous platform was, is, or will be located. The map data 210 can provide information about an environment or a geographic area. For example, the map data 210 can provide information regarding the identity and location of different travel ways (e.g., roadways, etc.), travel way segments (e.g., road segments, etc.), buildings, or other items or objects (e.g., lampposts, crosswalks, curbs, etc.); the location and directions of boundaries or boundary markings (e.g., the location and direction of traffic lanes, parking lanes, turning lanes, bicycle lanes, other lanes, etc.); traffic control data (e.g., the location and instructions of signage, traffic lights, other traffic control devices, etc.); obstruction information (e.g., temporary or permanent blockages, etc.); event data (e.g., road closures/traffic rule alterations due to parades, concerts, sporting events, etc.); nominal vehicle path data (e.g., indicating an ideal vehicle path such as along the center of a certain lane, etc.); or any other map data that provides information that assists an autonomous platform in understanding its surrounding environment and its relationship thereto. In some implementations, the map data 210 can include high-definition map information. Additionally or alternatively, the map data 210 can include sparse map data (e.g., lane graphs, etc.). In some implementations, the sensor data 204 can be fused with or used to update the map data 210 in real-time.

The autonomy system 200 can include the localization system 230 (e.g., a pose estimation system), which can provide an autonomous platform with an understanding of its location and orientation in an environment (its “pose”). In some examples, the localization system 230 can support one or more other subsystems of the autonomy system 200, such as by providing a unified local reference frame for performing, e.g., perception operations, planning operations, or control operations.

In some implementations, the localization system 230 can determine a current position of the autonomous platform. A current position can include a global position (e.g., respecting a georeferenced anchor, etc.), also referred to as “global pose,” or relative position (e.g., respecting an initial position of the autonomous vehicle, etc.), also referred to as “local pose.” For instance, the local pose can be defined relative to a coordinate frame or frame of reference established with respect to the initial position of the vehicle and updated as the vehicle moves relative to its initial position. The local pose can be consistent over short timeframes, such as timeframes on the order of several seconds. The local pose may be periodically refreshed. For instance, periodically refreshing the local pose may contribute to mitigating the effects of pose drift over time. The global pose may instead be defined relative to a global coordinate system, such as a tiled map grid.

The localization system 230 can generally include or interface with any device or circuitry for analyzing a position or change in position of an autonomous platform (e.g., autonomous ground-based vehicle, etc.). For example, the localization system 230 can determine position by using one or more of: inertial sensors (e.g., inertial measurement unit(s), etc.), a satellite positioning system (e.g., a global navigation satellite system (GNSS) such as GPS, BeiDou, GLONASS, Galileo, etc.), radio receivers, networking devices (e.g., based on IP address, etc.), triangulation or proximity to network access points or other network components (e.g., cellular towers, Wi-Fi access points, etc.), or other suitable techniques. The position of the autonomous platform can be used by various subsystems of the autonomy system 200 or provided to a remote computing system (e.g., using the communication interface(s) 206).

In some implementations, the localization system 230 can register relative positions of elements of a surrounding environment of an autonomous platform with recorded positions in the map data 210. For instance, the localization system 230 can process the sensor data 204 (e.g., LIDAR data, RADAR data, camera data, etc.) for aligning or otherwise registering to a map of the surrounding environment (e.g., from the map data 210) to understand the autonomous platform's position within that environment. Accordingly, in some implementations, the autonomous platform can identify its position within the surrounding environment (e.g., across six axes, etc.) based on a search over the map data 210. In some implementations, given an initial location, the localization system 230 can update the autonomous platform's location with incremental re-alignment based on recorded or estimated deviations from the initial location. In some implementations, a position can be registered directly within the map data 210.

In some implementations, the map data 210 can include a large volume of data subdivided into geographic tiles, such that a desired region of a map stored in the map data 210 can be reconstructed from one or more tiles. For instance, a plurality of tiles selected from the map data 210 can be stitched together by the autonomy system 200 based on a position obtained by the localization system 230 (e.g., a number of tiles selected in the vicinity of the position).

In some implementations, the localization system 230 can determine positions (e.g., relative or absolute) of one or more attachments or accessories for an autonomous platform. For instance, an autonomous platform can be associated with a cargo platform, and the localization system 230 can provide positions of one or more points on the cargo platform. For example, a cargo platform can include a trailer or other device towed or otherwise attached to or manipulated by an autonomous platform, and the localization system 230 can provide for data describing the position (e.g., absolute, relative, etc.) of the autonomous platform as well as the cargo platform. Such information can be obtained by the other autonomy systems to help operate the autonomous platform.

The autonomy system 200 can include the perception system 240, which can allow an autonomous platform to detect, classify, and track objects and actors in its environment. Environmental features or objects perceived within an environment can be those within the field of view of the sensor(s) 202 or predicted to be occluded from the sensor(s) 202. This can include object(s) not in motion or not predicted to move (static objects) or object(s) in motion or predicted to be in motion (dynamic objects/actors).

The perception system 240 can determine one or more states (e.g., current or past state(s), etc.) of one or more objects that are within a surrounding environment of an autonomous platform. For example, state(s) can describe (e.g., for a given time, time period, etc.) an estimate of an object's current or past location (also referred to as position); current or past speed/velocity; current or past acceleration; current or past heading; current or past orientation; size/footprint (e.g., as represented by a bounding shape, object highlighting, etc.); classification (e.g., pedestrian class vs. vehicle class vs. bicycle class, etc.); the uncertainties associated therewith; or other state information. In some implementations, the perception system 240 can determine the state(s) using one or more algorithms or machine-learned models configured to identify/classify objects based on inputs from the sensor(s) 202. The perception system can use different modalities of the sensor data 204 to generate a representation of the environment to be processed by the one or more algorithms or machine-learned models. In some implementations, state(s) for one or more identified or unidentified objects can be maintained and updated over time as the autonomous platform continues to perceive or interact with the objects (e.g., maneuver with or around, yield to, etc.). In this manner, the perception system 240 can provide an understanding about a current state of an environment (e.g., including the objects therein, etc.) informed by a record of prior states of the environment (e.g., including movement histories for the objects therein). Such information can be helpful as the autonomous platform plans its motion through the environment.

The autonomy system 200 can include the planning system 250, which can be configured to determine how the autonomous platform is to interact with and move within its environment. The planning system 250 can determine one or more motion plans for an autonomous platform. A motion plan can include one or more trajectories (e.g., motion trajectories) that indicate a path for an autonomous platform to follow. A trajectory can be of a certain length or time range. The length or time range can be defined by the computational planning horizon of the planning system 250. A motion trajectory can be defined by one or more waypoints (with associated coordinates). The waypoint(s) can be future location(s) for the autonomous platform. The motion plans can be continuously generated, updated, and considered by the planning system 250.

The motion planning system 250 can determine a strategy for the autonomous platform. A strategy can be a set of discrete decisions (e.g., yield to actor, reverse yield to actor, merge, lane change) that the autonomous platform makes. The strategy can be selected from a plurality of potential strategies. The selected strategy can be a lowest cost strategy as determined by one or more cost functions. The cost functions may, for example, evaluate the probability of a collision with another actor or object.

The planning system 250 can determine a desired trajectory for executing a strategy. For instance, the planning system 250 can obtain one or more trajectories for executing one or more strategies. The planning system 250 can evaluate trajectories or strategies (e.g., with scores, costs, rewards, constraints, etc.) and rank them. For instance, the planning system 250 can use forecasting output(s) that indicate interactions (e.g., proximity, intersections, etc.) between trajectories for the autonomous platform and one or more objects to inform the evaluation of candidate trajectories or strategies for the autonomous platform. In some implementations, the planning system 250 can utilize static cost(s) to evaluate trajectories for the autonomous platform (e.g., “avoid lane boundaries,” “minimize jerk,” etc.). Additionally or alternatively, the planning system 250 can utilize dynamic cost(s) to evaluate the trajectories or strategies for the autonomous platform based on forecasted outcomes for the current operational scenario (e.g., forecasted trajectories or strategies leading to interactions between actors, forecasted trajectories or strategies leading to interactions between actors and the autonomous platform, etc.). The planning system 250 can rank trajectories based on one or more static costs, one or more dynamic costs, or a combination thereof. The planning system 250 can select a motion plan (and a corresponding trajectory) based on a ranking of a plurality of candidate trajectories. In some implementations, the planning system 250 can select a highest ranked candidate, or a highest ranked feasible candidate.

The planning system 250 can then validate the selected trajectory against one or more constraints before the trajectory is executed by the autonomous platform.

To help with its motion planning decisions, the planning system 250 can be configured to perform a forecasting function. The planning system 250 can forecast future state(s) of the environment. This can include forecasting the future state(s) of other actors in the environment. In some implementations, the planning system 250 can forecast future state(s) based on current or past state(s) (e.g., as developed or maintained by the perception system 240). In some implementations, future state(s) can be or include forecasted trajectories (e.g., positions over time) of the objects in the environment, such as other actors. In some implementations, one or more of the future state(s) can include one or more probabilities associated therewith (e.g., marginal probabilities, conditional probabilities). For example, the one or more probabilities can include one or more probabilities conditioned on the strategy or trajectory options available to the autonomous platform. Additionally or alternatively, the probabilities can include probabilities conditioned on trajectory options available to one or more other actors.

In some implementations, the planning system 250 can perform interactive forecasting. The planning system 250 can determine a motion plan for an autonomous platform with an understanding of how forecasted future states of the environment can be affected by execution of one or more candidate motion plans. By way of example, with reference again to FIG. 1, the autonomous platform 110 can determine candidate motion plans corresponding to a set of platform trajectories 112A-C that respectively correspond to the first actor trajectories 122A-C for the first actor 120, trajectories 132 for the second actor 130, and trajectories 142 for the third actor 140 (e.g., with respective trajectory correspondence indicated with matching line styles). For instance, the autonomous platform 110 (e.g., using its autonomy system 200) can forecast that a platform trajectory 112A to more quickly move the autonomous platform 110 into the area in front of the first actor 120 is likely associated with the first actor 120 decreasing forward speed and yielding more quickly to the autonomous platform 110 in accordance with first actor trajectory 122A. Additionally or alternatively, the autonomous platform 110 can forecast that a platform trajectory 112B to gently move the autonomous platform 110 into the area in front of the first actor 120 is likely associated with the first actor 120 slightly decreasing speed and yielding slowly to the autonomous platform 110 in accordance with first actor trajectory 122B. Additionally or alternatively, the autonomous platform 110 can forecast that a platform trajectory 112C to remain in a parallel alignment with the first actor 120 is likely associated with the first actor 120 not yielding any distance to the autonomous platform 110 in accordance with first actor trajectory 122C. Based on comparison of the forecasted scenarios to a set of desired outcomes (e.g., by scoring scenarios based on a cost or reward), the planning system 250 can select a motion plan (and its associated trajectory) in view of the autonomous platform's interaction with the environment 100. In this manner, for example, the autonomous platform 110 can interleave its forecasting and motion planning functionality.

To implement selected motion plan(s), the autonomy system 200 can include a control system 260 (e.g., a vehicle control system). Generally, the control system 260 can provide an interface between the autonomy system 200 and the platform control devices 212 for implementing the strategies and motion plan(s) generated by the planning system 250. For instance, the control system 260 can implement the selected motion plan/trajectory to control the autonomous platform's motion through its environment by following the selected trajectory (e.g., the waypoints included therein). The control system 260 can, for example, translate a motion plan into instructions for the appropriate platform control devices 212 (e.g., acceleration control, brake control, steering control, etc.). By way of example, the control system 260 can translate a selected motion plan into instructions to adjust a steering component (e.g., a steering angle) by a certain number of degrees, apply a certain magnitude of braking force, increase/decrease speed, etc. In some implementations, the control system 260 can communicate with the platform control devices 212 through communication channels including, for example, one or more data buses (e.g., controller area network (CAN), etc.), onboard diagnostics connectors (e.g., OBD-II, etc.), or a combination of wired or wireless communication links. The platform control devices 212 can send or obtain data, messages, signals, etc. to or from the autonomy system 200 (or vice versa) through the communication channel(s).

The autonomy system 200 can receive, through communication interface(s) 206, assistive signal(s) from remote assistance system 270. Remote assistance system 270 can communicate with the autonomy system 200 over a network (e.g., as a remote system 160 over network 170). In some implementations, the autonomy system 200 can initiate a communication session with the remote assistance system 270. For example, the autonomy system 200 can initiate a session based on or in response to a trigger. In some implementations, the trigger can be an alert, an error signal, a map feature, a request, a location, a traffic condition, a road condition, etc.

After initiating the session, the autonomy system 200 can provide context data to the remote assistance system 270. The context data can include sensor data 204 and state data of the autonomous platform. For example, the context data can include a live camera feed from a camera of the autonomous platform and the autonomous platform's current speed. An operator (e.g., human operator) of the remote assistance system 270 can use the context data to select assistive signals. The assistive signal(s) can provide values or adjustments for various operational parameters or characteristics for the autonomy system 200. For instance, the assistive signal(s) can include way points (e.g., a path around an obstacle, lane change, etc.), velocity or acceleration profiles (e.g., speed limits, etc.), relative motion instructions (e.g., convoy formation, etc.), operational characteristics (e.g., use of auxiliary systems, reduced energy processing modes, etc.), or other signals to assist the autonomy system 200.

The autonomy system 200 can use the assistive signal(s) for input into one or more autonomy subsystems for performing autonomy functions. For instance, the planning subsystem 250 can receive the assistive signal(s) as an input for generating a motion plan. For example, assistive signal(s) can include constraints for generating a motion plan. Additionally or alternatively, assistive signal(s) can include cost or reward adjustments for influencing motion planning by the planning subsystem 250. Additionally or alternatively, assistive signal(s) can be considered by the autonomy system 200 as suggestive inputs for consideration in addition to other received data (e.g., sensor inputs, etc.).

The autonomy system 200 can be platform agnostic, and the control system 260 can provide control instructions to platform control devices 212 for a variety of different platforms for autonomous movement (e.g., a plurality of different autonomous platforms fitted with autonomous control systems). This can include a variety of different types of autonomous vehicles (e.g., sedans, vans, SUVs, trucks, electric vehicles, combustion power vehicles, etc.) from a variety of different manufacturers/developers that operate in various different environments and, in some implementations, perform one or more vehicle services.

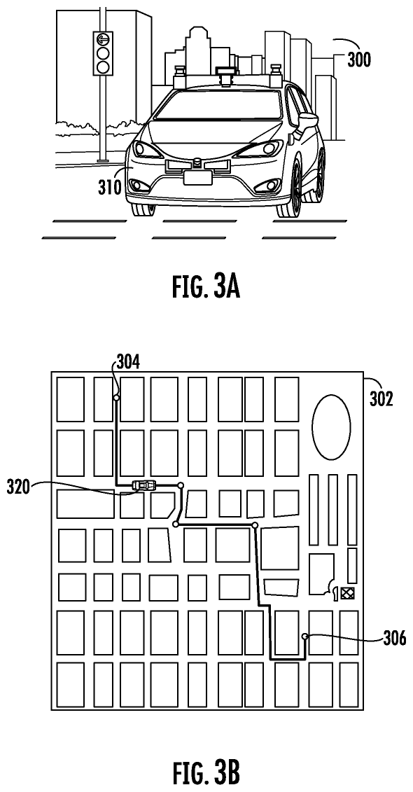

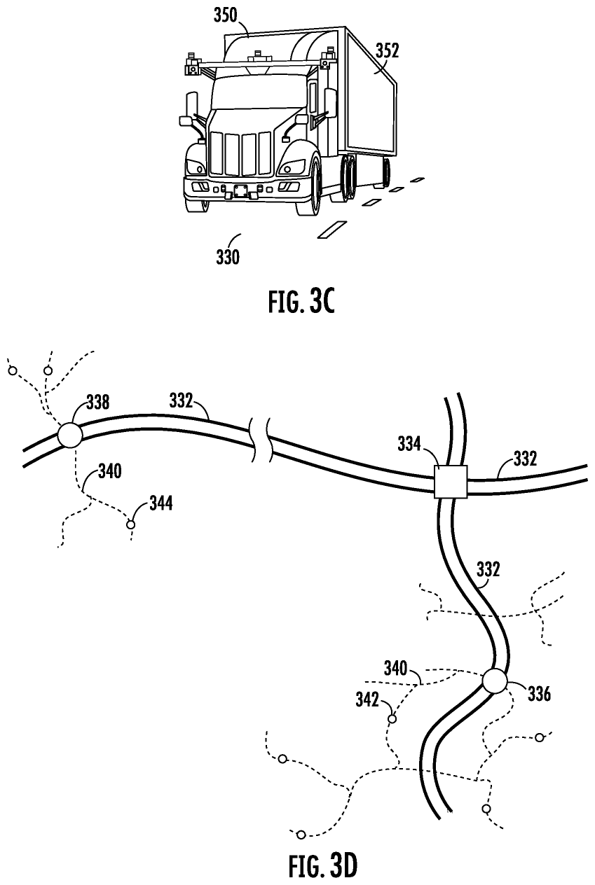

For example, with reference to FIG. 3A, an operational environment can include a dense environment 300. An autonomous platform can include an autonomous vehicle 310 controlled by the autonomy system 200. In some implementations, the autonomous vehicle 310 can be configured for maneuverability in a dense environment, such as with a configured wheelbase or other specifications. In some implementations, the autonomous vehicle 310 can be configured for transporting cargo or passengers. In some implementations, the autonomous vehicle 310 can be configured to transport numerous passengers (e.g., a passenger van, a shuttle, a bus, etc.). In some implementations, the autonomous vehicle 310 can be configured to transport cargo, such as large quantities of cargo (e.g., a truck, a box van, a step van, etc.) or smaller cargo (e.g., food, personal packages, etc.).

With reference to FIG. 3B, a selected overhead view 302 of the dense environment 300 is shown overlaid with an example trip/service between a first location 304 and a second location 306. The example trip/service can be assigned, for example, to an autonomous vehicle 320 by a remote computing system. The autonomous vehicle 320 can be, for example, the same type of vehicle as autonomous vehicle 310. The example trip/service can include transporting passengers or cargo between the first location 304 and the second location 306. In some implementations, the example trip/service can include travel to or through one or more intermediate locations, such as to onload or offload passengers or cargo. In some implementations, the example trip/service can be prescheduled (e.g., for regular traversal, such as on a transportation schedule). In some implementations, the example trip/service can be on-demand (e.g., as requested by or for performing a taxi, rideshare, ride hailing, courier, delivery service, etc.).

With reference to FIG. 3C, in another example, an operational environment can include an open travel way environment 330. An autonomous platform can include an autonomous vehicle 350 controlled by the autonomy system 200. This can include an autonomous tractor for an autonomous truck. In some implementations, the autonomous vehicle 350 can be configured for high payload transport (e.g., transporting freight or other cargo or passengers in quantity), such as for long distance, high payload transport. For instance, the autonomous vehicle 350 can include one or more cargo platform attachments such as a trailer 352. Although depicted as a towed attachment in FIG. 3C, in some implementations one or more cargo platforms can be integrated into (e.g., attached to the chassis of, etc.) the autonomous vehicle 350 (e.g., as in a box van, step van, etc.).

With reference to FIG. 3D, a selected overhead view of open travel way environment 330 is shown, including travel ways 332, an interchange 334, transfer hubs 336 and 338, access travel ways 340, and locations 342 and 344. In some implementations, an autonomous vehicle (e.g., the autonomous vehicle 310 or the autonomous vehicle 350) can be assigned an example trip/service to traverse the one or more travel ways 332 (optionally connected by the interchange 334) to transport cargo between the transfer hub 336 and the transfer hub 338. For instance, in some implementations, the example trip/service includes a cargo delivery/transport service, such as a freight delivery/transport service. The example trip/service can be assigned by a remote computing system. In some implementations, the transfer hub 336 can be an origin point for cargo (e.g., a depot, a warehouse, a facility, etc.) and the transfer hub 338 can be a destination point for cargo (e.g., a retailer, etc.). However, in some implementations, the transfer hub 336 can be an intermediate point along a cargo item's ultimate journey between its respective origin and its respective destination. For instance, a cargo item's origin can be situated along the access travel ways 340 at the location 342. The cargo item can accordingly be transported to the transfer hub 336 (e.g., by a human-driven vehicle, by the autonomous vehicle 310, etc.) for staging. At the transfer hub 336, various cargo items can be grouped or staged for longer distance transport over the travel ways 332.

In some implementations of an example trip/service, a group of staged cargo items can be loaded onto an autonomous vehicle (e.g., the autonomous vehicle 350) for transport to one or more other transfer hubs, such as the transfer hub 338. For instance, although not depicted, it is to be understood that the open travel way environment 330 can include more transfer hubs than the transfer hubs 336 and 338, and can include more travel ways 332 interconnected by more interchanges 334. A simplified map is presented here for purposes of clarity only. In some implementations, one or more cargo items transported to the transfer hub 338 can be distributed to one or more local destinations (e.g., by a human-driven vehicle, by the autonomous vehicle 310, etc.), such as along the access travel ways 340 to the location 344. In some implementations, the example trip/service can be prescheduled (e.g., for regular traversal, such as on a transportation schedule). In some implementations, the example trip/service can be on-demand (e.g., as requested by or for performing a chartered passenger transport or freight delivery service).

To improve the performance of an autonomous platform, such as an autonomous vehicle controlled at least in part using autonomy system(s) 200 (e.g., the autonomous vehicles 310 or 350), systems and methods according to example aspects of the present disclosure can provide for improved localization of an autonomous platform within its environment. In particular, the systems and methods disclosed herein can employ a LIDAR odometry module to estimate pose of the autonomous platform based on a comparison between a LIDAR observation, captured relative to a known pose of the autonomous platform, and a progressively-updated, real-time local surfel map of the platform's environment.

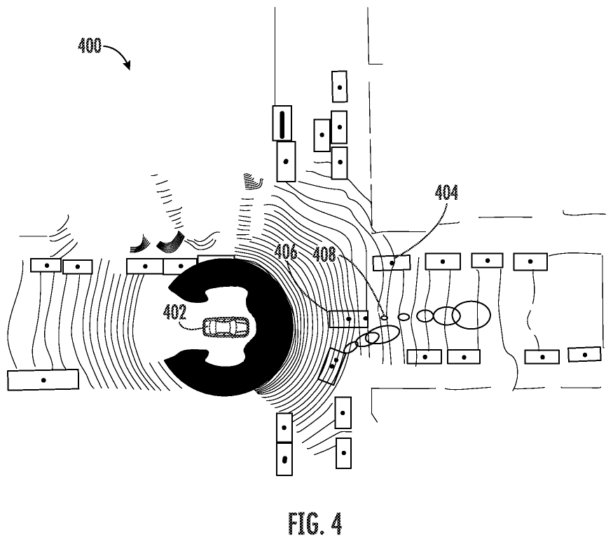

FIG. 4 is a diagram of an example LIDAR observation 400. The LIDAR observation 400 is annotated with information about actors. The LIDAR observation 400 can be obtained from one or more LIDAR sensors. The LIDAR observation 400 can be or can include a LIDAR point cloud. The LIDAR point cloud can include one or more LIDAR points. The LIDAR point(s) in the LIDAR point cloud can encode extensive data about an environment, such as intensity, classification of features, timestamps, and so on relative to a given coordinate frame associated with the LIDAR observation. The coordinate frame may be, for example, an X, Y, Z coordinate frame or other suitable coordinate frame. The LIDAR observation 400 can be oriented relative to a vehicle frame, where the vehicle frame is oriented with respect to a pose of a vehicle 402. The vehicle frame can be a coordinate frame related to the pose of the vehicle 402 at the current time at which the LIDAR observation 400 is captured. For instance, the LIDAR data points may be arranged relative to an origin centered on the pose of the vehicle 402. Additionally or alternatively, the coordinate frame of the LIDAR observation 400 may be the vehicle frame itself. As one example, the LIDAR observation 400 may be captured relative to the pose of a vehicle 402 in a vehicle frame such that the LIDAR points are arranged based on a time of flight from the vehicle 402, as estimated by the vehicle's known pose. In some cases, the origin of the vehicle frame may not necessarily be the pose of the vehicle 402 itself. However, the pose of the vehicle 402 can be known in the vehicle frame.

The LIDAR observation 400 can be annotated with bounding boxes 404 describing the location of objects or actors within the environment of the vehicle 402. For instance, the bounding boxes 404 may describe locations of vehicles, pedestrians, or other objects of interest within the environment. The bounding boxes 404 may be produced by the LIDAR systems themselves or by other systems, such as perception systems. In addition, actors 406 may be annotated with a trajectory 408 describing forecasted motion of the actors 406 over time. For instance, a perception system may predict that actor 406 will move according to the trajectory 408.

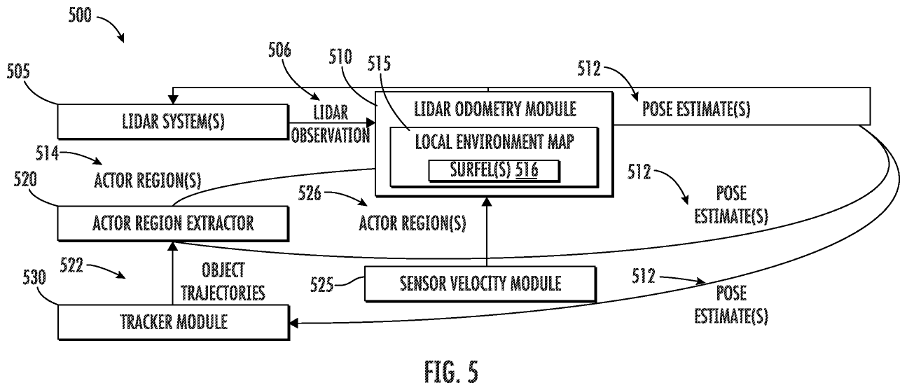

FIG. 5 is a block diagram of an example portion of a vehicle control system 500, according to some implementations of the present disclosure. The vehicle control system 500 can be located onboard a vehicle. For example, the vehicle control system 500 can be an autonomous vehicle control system located onboard an autonomous vehicle.

The system 500 can include one or more LIDAR systems 505 configured to provide LIDAR observations 506 to a LIDAR odometry module 510. The LIDAR observation 506 can be obtained from one or more LIDAR sensors. The LIDAR observation 506 can be or can include a LIDAR point cloud. The LIDAR point cloud can include one or more LIDAR points. The LIDAR point(s) in the LIDAR point cloud can encode extensive data about an environment, such as intensity, classification of features, timestamps, and so on relative to a given coordinate frame associated with the LIDAR observation 506. For example, the LIDAR observation 506 can be or include the LIDAR observation 400.

The LIDAR odometry module 510 can produce pose estimates 512 of a vehicle by transforming a pose from the LIDAR observations 506 based on an alignment between a local environment map 515 descriptive of the environment of the vehicle and the LIDAR observations 506.

The local environment map 515 can be a regularly, progressively-updated map of the environment of the vehicle that is generated primarily (or entirely) from data captured on-board the vehicle. In some implementations, the local environment map 515 is generated using, at least in part, data from one or more prior LIDAR observations 506. For instance, the local environment map 515 may be generated (in real-time) from LIDAR observations 506 aggregated over a current operational instance of a vehicle. For instance, the local environment map 515 may be routinely updated based on one or more LIDAR observations 506 captured during the current operational instance. As an example, new LIDAR observations 506 may be fitted to the existing local environment map 515 based on LIDAR data (e.g., LIDAR points) that are representative of data already included in the local environment map.

In some implementations, the local environment map 515 may be a point cloud or, alternatively, some simplified geometric representation of the environment of the vehicle, such as a surfel map. Generally, the use of a simplified geometric representation can provide for improved aggregation of data across multiple LIDAR observations 506 and provide for reduced computational requirements for reasoning about the environment of the vehicle.

The local environment map 515 may be oriented relative to a keyframe. As used herein, a “keyframe” is a representation of a local coordinate frame for a given vehicle and a given local environment map 515. The vehicle may transition between multiple keyframes as it navigates its environment based on distance or time traveled by the vehicle. For instance, the keyframe may be relatively temporary in nature, and a keyframe may be periodically refreshed to negate the effects of drift and stale data over long trips. A keyframe may include any suitable representation or data structure for conveying a frame of reference, such as, for example, origin coordinates, transforms from a previous keyframe, headings, such as a heading relative to coordinates, compass directions, previous headings, and so on, or other suitable representation or data structure.

Periodically shifting the coordinate system of the local environment map 515 can provide for ensuring that the localization problem remains numerically well-conditioned, and facilitate modeling of measurements to relative, observable coordinate systems. Furthermore, translating the local environment map 515 across keyframes can provide that the current pose of the vehicle is generally near the origin of the local environment map 515, which can ensure relatively computationally simple transformations between keyframes over the duration of the vehicle's trip.

For instance, in one example implementation, an initial keyframe is established at the start of a vehicle's travel, after the vehicle has collected some initial amount of data. The initial keyframe is used to orient the local environment map 515 for that vehicle's travel over some distance or time. Once the vehicle has traveled a certain distance or for a certain amount of time, the vehicle establishes a new keyframe (e.g., centered on or near the vehicle's current location). Some or all of the data in the local environment map 515 is then transformed to the new keyframe (e.g., based on the displacement between the original keyframe's origin and the new keyframe's origin) to generate a second local environment map 515, which is used in place of the original map. In some implementations, data older than some threshold or at a greater distance than some threshold may not be translated to the second local environment map 515 to prune data that is increasingly less relevant to the system 500. This process can repeat for the duration of the vehicle's trip.

In some implementations, the local environment map 515 can be a surfel map including a plurality of surfels 516. A surfel, or “surface element,” is a geometric structure used to approximate or represent a surface in the environment of the vehicle. In one example implementation, a surfel can be or can include a disc defined by a position vector, a normal vector, and a radius. The position vector can describe the location of the centroid of the disc (relative to a given coordinate frame, such as the keyframe). The normal vector can describe the size and/or orientation of the surfel in three-dimensional space. For instance, the normal vector may define the radius or radii of the surfel. As another example, the normal vector can define the approximate surface normal at the centroid. The radius can define the distance from the centroid of the surfel to the edge of the surfel.

In some implementations, the resolution of the local environment map 515 may decrease at farther distances from the position of the vehicle. For instance, in some implementations, the size of surfels in the local environment map 515 may be smaller at positions close to the vehicle such that the immediate environment of the vehicle is represented with a high resolution. This can provide improved reasoning capabilities about the immediate environment of the vehicle. Additionally or alternatively, surfels farther from the vehicle may be larger and sparser such that comparatively less processing power is spent reasoning about surfels that do not represent portions of the environment near the vehicle.

The LIDAR odometry module 510 can determine a transform between a vehicle frame and a keyframe by aligning the LIDAR observation 506 to the local environment map 515 based on a similarity between the LIDAR observation 506 and the local environment map 515. The transform can be used to obtain the vehicle's position in the keyframe based on the alignment between the LIDAR observation 506 and the local environment map 515. For instance, the local environment map 515 can represent the environment's geometry with planar elements such as surfels. The transform between the two frames can therefore be found by minimizing the point-to-plane error between the LIDAR observation 506 and the local environment map 515.

For instance, in some implementations, the LIDAR odometry module 510 may align the LIDAR observation 506 to the plurality of surfels of the local environment map 515 to minimize an aggregate distance between the LIDAR observation 506 and the plurality of surfels. The aggregate distance between the LIDAR observation 506 and the plurality of surfels can be the sum of some or all distances between each point in the LIDAR observation 506 and a closest centroid (or closest point) on a respective surfel of the plurality of surfels. Furthermore, in some implementations, minimizing the aggregate distance between the LIDAR observation 506 and the plurality of surfels can include minimizing the aggregate distance between each LIDAR point in the LIDAR point cloud of the LIDAR observation 506 and a corresponding surfel (e.g., a surface of a corresponding surfel) of the plurality of surfels. The distance calculation may utilize or be based on the normal vector of the corresponding surfel. For instance, the distance along the normal vector may be minimized. As one example, the distance calculation may be based on a component of the distance between the LIDAR point and the surfel in the direction of the normal vector of the surfel. Additionally or alternatively, instead of considering aggregate distance, the system 500 may instead minimize the average distance between a LIDAR point and corresponding surfel across all points and surfels. For instance, in some implementations, minimizing the aggregate distance between the LIDAR observation 506 and the plurality of surfels can include minimizing an average distance between each LIDAR point in the LIDAR point cloud and the normal vector of a corresponding surfel of the plurality of surfels.

In some implementations, the system 500 can match LIDAR points to centroids of the surfels by transforming the points to the vehicle frame using the estimated transform from a previous iteration, then searching for a closest centroid. An initial guess of alignment can be computed using a previous estimate of the transform from a previous iteration, updated using a relative motion estimate from local pose. For instance, the relative motion estimate may be provided by another module onboard the vehicle, such as a global map, an inertial motion unit, a RADAR sensor, or any other suitable module. In some implementations, a dense grid is used to accelerate the closest point search while maintaining the algorithmic complexity of the matching task as a linear cost relative to the number of points and independent of the number of surfels. In some implementations, correspondences may be recomputed at each iteration. This can provide for an indirect rejection of outliers outside of the correspondence radius.

In some implementations, the system 500 can minimize the robustified least squares cost. For instance, in some implementations, the system 500 can employ the Levenberg-Marquardt algorithm to minimize the robusitified least squares cost. This robustifier can be approximated by iterative reweighting. The algorithm can be considered to converge when the system 500 is unable to improve cost due to a prohibitively small step size, or based on a determination by a local quadratic model that the cost cannot be improved. In some implementations, aligning the LIDAR observation 506 to the plurality of surfels is performed over a fixed number of iterations. The pose estimate 512 of the vehicle may not be determined if the aggregate distance between the LIDAR observation 506 and the plurality of surfels is not resolved over the fixed number of iterations. If the system 500 does not find a local minimum (e.g., within a given number of iterations), the system 500 may skip publishing a pose estimate 512 for the iteration and begin a new iteration. In this manner, the system 500 may be robust to minor outages in data availability.

In some implementations, during alignment of the LIDAR observation 506 and local environment map 515, the system 500 may mask or otherwise omit regions of the LIDAR observation 506 corresponding to moving objects, or “actors.” An actor region extractor 520 can be configured to extract actor regions 514 from the perception module 530 and provide the actor regions to the LIDAR odometry module 510. These actor regions 514 may not accurately represent static portions of the environment of the vehicle. For instance, in some implementations, the LIDAR odometry module may mask the one or more actor regions 514 in the LIDAR observation 506, wherein the one or more actor region(s) 514 include data associated with a moving object. For instance, the actor region 514 can include one or more LIDAR points associated with an actor. Masking the one or more actor region(s) 514 can include omitting the one or more actor region(s) 514 from the LIDAR observations 506 when determining a transform for generating the pose estimates 512 by aligning the LIDAR observation 506 to the local environment map 515. The actor region(s) 514 (e.g., the masks) can be represented by bounding boxes supplied by other modules of the vehicle, such as forecasted object trajectories 522 of objects from a tracker module 530. As one example, the system 500 can utilize object trajectories 522 from the tracker module 530 that are not designated as signs or construction, which may be desirable to include in the local environment map 515, as opposed to trajectories corresponding to pedestrians or other vehicles, which may desirably be masked. The actor region extractor 520 and the tracker module 530 can utilize the pose estimate(s) 512 from the LIDAR odometry module 510 to represent the current position of the vehicle. In addition, the LIDAR odometry module can receive actor region(s) 526 from a sensor velocity module 525 of a RADAR system. These actor region(s) 526 may be represented by bounding boxes or other indications of actors determined by the sensor velocity module 525 (e.g., from the respective RADAR system).

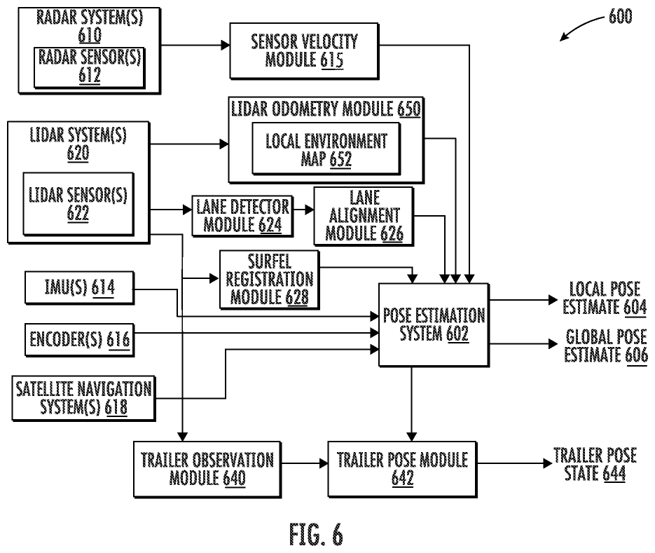

FIG. 6 is a block diagram of a portion of a vehicle control system 600, according to some implementations of the present disclosure. The vehicle control system 600 can be located onboard a vehicle. For example, the vehicle control system 600 can be a vehicle control system located onboard an autonomous vehicle.

FIG. 6 depicts inputs and outputs of a pose estimation system 602 according to example aspects of the present disclosure. The pose estimation system 602 can employ a localization filter to produce a local pose estimate 604 and/or a global pose estimate 606, as described herein. In addition to the localization filter, the pose estimation system 602 can include one or more measurement buffers, state machines, and/or other systems for fusing measurements from distinct input sources. One example of a localization filter is a Kalman filter. A Kalman filter, or linear quadratic estimation filter, is an algorithm utilizing a series of measurements over time (which can include noise, biases, or other inaccuracies) to produce estimates of other, unknown variables. The Kalman filter can estimate a joint probability distribution over the variables at each time frame. The Kalman filter can employ a two-phase prediction process, in which the filter produces initial estimates of current state variables and uncertainties, then updates these estimates with a weighted average after the next measurement is observed. The use of a Kalman filter can provide for processing several measurements in real time, which is beneficial for autonomous platform navigation tasks.

In some implementations, the localization filter can be or can include one or more parallel filters. For instance, the localization filter can include a local pose filter configured to output a local pose estimate or a global pose filter configured to output a global pose estimate. The use of parallel filters can provide for improved insulation of the local pose estimate 604. Additionally or alternatively, the localization filter can be or can include a combined filter. For instance, in some implementations, the localization filter can be a single filter configured to output pose estimates including both local pose estimate 604 and global pose estimate 606. The use of a combined filter can provide an improved sensor fusion framework, along with improvements to computing technology such as reduced computational requirements or reduced memory resources dedicated to recording data.

The localization filter can consume inputs from a plurality of sensor systems or other onboard systems on a vehicle (e.g., autonomous vehicle 310) to produce the pose estimates 604, 606. The inputs can include any suitable inputs from any suitable systems onboard or in communication with an autonomy system (e.g., autonomy system 200) such as, for example, range data (e.g., from a LIDAR system or RADAR system), doppler data encoding velocities associated with the range data (e.g., doppler RADAR data and/or doppler LIDAR data), encoder inputs (e.g., from wheel encoders), an IMU accumulator input (e.g., from an IMU accumulator system), sensor alignment data, LIDAR alignment data (e.g., from a LIDAR alignment tracking module), lane alignment data (e.g., from a lane alignment tracking module), map data, such as one or more map tiles (e.g., from a map data server, a global navigation satellite system (GNSS), etc.), and/or doppler data associated with the map data (e.g., doppler data from a satellite system), and pose estimates from a LIDAR odometry module, as described herein.

LIDAR alignment data can provide a three-dimensional geometric registration of LIDAR returns with respect to registered surface elements (surfels) in a given map tile. For instance, a LIDAR alignment module can receive a measurement of global pose from a three-dimensional transformation of a tile from sensor state. The transformation can be a homogenous transformation of the pose of a given tile frame from an estimated LIDAR frame. A LIDAR alignment module can determine the location of LIDAR points with respect to the transformed global pose.

Lane alignment data can be a three-dimensional geometric registration of detected lane line points (e.g., lane boundaries) with respect to annotations in a map tile. For instance, a lane alignment module 626 can receive a measurement of global pose from a three-dimensional transformation between a first reference frame that is relative to a tiled global map and a second reference frame that is relative to a vehicle, a sensor, or other local frame. The transformation can be a homogenous transformation of the pose of a given tile frame from an estimated LIDAR frame. The lane alignment module 626 can determine the location of lane line points with respect to the transformed global pose.

As used herein, a “local pose” (such as local pose estimate 604) can be defined relative to an initial position of an autonomous vehicle. The local pose can be consistent over short timeframes, such as timeframes on the order of several seconds. The local pose may be periodically refreshed. For instance, periodically refreshing the local pose may contribute to mitigating the effects of pose drift over time. The local pose can be defined relative to a local frame. The local frame can reflect the initial position and/or heading of the autonomous vehicle. The Z-axis of the local frame can be aligned with gravity. Additionally or alternatively, the X-axis and/or Y-axis of the local frame can generally be aligned with dimensions of freedom over which the autonomous vehicle may travel (e.g., the ground).

In some implementations, the local pose published as the pose estimates can be formed by integrating an estimated velocity state in the localization filter. Integrating the estimated velocity state to determine the local pose estimate 604 can provide for continuity of local pose position states even in the presence of arbitrarily large jumps in map-tile-relative states. The local pose estimate 604 can be formed by combining roll and pitch from the localization filter with position and heading of a previous local pose transform, then integrating the estimated body-fixed velocity states from the localization filter to produce a new local pose transform.

Additionally or alternatively, the pose estimates can include a global pose estimate 606. The global pose estimate 606 can be defined relative to a global metric. As one example, the global pose estimate 606 can be defined relative to one or more coordinates. As another example, the global pose can be defined relative to a tiled global map. The tiled global map can include map data defined relative to one or more “map tiles” or simply “tiles” that encompass sections of the overall map. For instance, a larger map or atlas can be segmented into a plurality of map tiles that each cover a subset of the larger map or atlas. In this way, analysis of objects on a global map can be focused on objects that are within a proximate frame of reference. The global pose estimate 606 can be defined relative to a tile frame. Each tile in the tiled global map can include a respective origin, and a global pose of the vehicle can be estimated (via the global pose estimate 606) with respect to a given tile frame in which the vehicle is located. Global pose can be used to place map content into the local or vehicle frame.

The localization filter can perform covariance gating to fuse the inputs from multiple sources. Covariance gating is used to determine the likelihood of a measurement given an internal state of the localization filter (e.g., based on previous measurements and the dynamic model(s) of the localization filter) that is compared to a gating threshold to determine whether the measurement is erroneous or not. For example, if one input, such as LIDAR alignment, produces measurements for a given state that do not agree with other inputs such as sensor velocities, lane alignment, IMU accumulator data, and so on, the likelihood of the disagreeing input can be beyond the gating threshold. A measurement that is beyond the gating threshold can be flagged as erroneous and/or may not be fused with other measurements from the system.

The system 600 can include one or more RADAR systems 610. Each RADAR system 610 can include one or more RADAR sensors 612. The RADAR systems 610 or RADAR sensors 612 can be positioned onboard an autonomous platform, such as an autonomous vehicle. For instance, each RADAR system 610 can have a field of view that covers a portion of an autonomous vehicle's environment. In some implementations, the RADAR system 610 can be or include Doppler RADARs.

The RADAR system(s) 610 or RADAR sensor(s) 612 can be associated with a sensor velocity module 615. The sensor velocity module 615 can be configured to estimate the velocity of the RADAR system 610 based on RADAR data from the RADAR sensors 612. For instance, the sensor velocity measurements can be the three-dimensional velocity of a given sensor with respect to the local frame or expressed in the sensor frame. These sensor velocity measurements can be computed from doppler readings of sensor returns (such as doppler RADAR or doppler LIDAR). In some implementations, a multiplicative bias may be applied to the sensor velocity measurements to compensate for any miscalibration of the RADAR system 610 (e.g., a RADAR array).

The velocity can be estimated with respect to the local frame. In some implementations, a velocity common to each RADAR sensor 612 can be estimated for each RADAR system 610. For instance, a common velocity may be estimated for a single RADAR sensor 612 and applied to each of the other RADAR sensor(s) 612 as being representative of the velocity of each of the RADAR sensors 612, rather than computing a unique velocity for each RADAR sensor 612. Additionally or alternatively, in some implementations, a respective sensor velocity module 615 can be connected to a RADAR sensor 612 and configured to estimate a respective velocity for the connected RADAR sensor 612.

Additionally or alternatively, the system 600 can include one or more LIDAR systems 620. Each LIDAR system 620 can include one or more LIDAR sensors 622. The LIDAR systems 620 or LIDAR sensors 622 can be positioned onboard a vehicle, such as an autonomous vehicle or autonomous platform. For instance, each LIDAR system 620 can have a field of view that covers a portion of a vehicle's environment. In some implementations, sensor velocity measurements may be associated with the LIDAR sensors 622.

The system 600 can also include one or more modules to extract geographic or other identifiers from the LIDAR data produced by the LIDAR system(s) 620. As one example, the system 600 can include a lane detector module 624. The lane detector module 624 can analyze the LIDAR data to detect and orient lane boundaries in the environment of the autonomous platform that are visible in the LIDAR data. The detected lanes can be passed to a lane alignment module 626. The lane alignment module 626 can align the detected lanes with respect to a sensor frame, such as the vehicle.

Additionally or alternatively, the system 600 can include a surfel registration module 628. The surfel registration module 628 can match LIDAR data from the LIDAR system(s) 620 to known surfels on a larger surfel map. For instance, the surfel registration module 628 can reconcile multiple views of LIDAR data in a consistent frame of reference based on the pose estimates of the vehicle and the distance between the vehicle and consistent features in the multiple views of LIDAR data.

Furthermore, according to example aspects of the present disclosure, the system 600 can include a LIDAR odometry module 650. The LIDAR odometry module 650 can maintain a local environment map 652 of a vehicle's environment generated from recent LIDAR observations. from the LIDAR system(s) 620. The local environment map 652 can be oriented with respect to a keyframe corresponding to the vehicle's pose at some recent, prior point in time. The local environment map 652 can be progressively updated with data from new LIDAR observations as the vehicle traverses its environment. For instance, the local environment map 652 may be generated (in real-time) from LIDAR observations from the LIDAR system(s) 620 that are aggregated over a current operational instance of a vehicle. For instance, the local environment map 652 may be routinely updated based on one or more LIDAR observations captured during the current operational instance. As an example, new LIDAR observations may be fitted to the existing local environment map 652 based on LIDAR data (e.g., LIDAR points) that are representative of data already included in the local environment map. Periodically, the LIDAR odometry module 650 can refresh the local environment map 652 by establishing a new keyframe at the vehicle's current pose, translating the data from the prior local environment map 652 such that the prior data is oriented relative to the new keyframe instead of the prior keyframe. New LIDAR observations can then be applied to update the translated data at the new keyframe.

Furthermore, the LIDAR odometry module 650 can generate a pose estimate for the vehicle by aligning a current LIDAR observation, oriented with respect to a vehicle frame, to the local environment map 652. For instance, the LIDAR observation can include a plurality of LIDAR points, and the local environment map 652 can include a plurality of surfels. The LIDAR odometry module 650 can control for (e.g., minimize) the total or average distance between the LIDAR points and corresponding surfels to determine a transform between the vehicle frame and the keyframe of the local environment map 652. The transform can best match the LIDAR observation data to what is known of the environment based on the local environment map 652. Furthermore, the pose estimate of the vehicle in the keyframe can be determined by applying the transform to the pose of the vehicle in the vehicle frame (e.g., the origin of the vehicle frame). In this manner, the LIDAR odometry module 650 can produce accurate pose estimates of the vehicle in real-time that accounts for the most current available state of the vehicle's surroundings.

Additionally or alternatively, the system 600 can include one or more inertial measurement units (IMUs) 614. The IMUs 614 can include accelerometers, gyroscopes, magnetometers, compasses, etc. to measure orientation, specific force, angular rate, or other motion characteristics of the autonomous platform. One example IMU includes a three-axis accelerometer and a three-axis rate gyroscope. The IMU can be connected over a vehicle bus (e.g., the vehicle's CAN bus). The axes can be sampled independently or together and provided as messages over the bus. For instance, the IMUs 614 can output IMU data. In some implementations, an IMU accumulator can be included to accumulate data from the IMUs 614 over time and generate a persistent orientation measurement based on transient signals from the IMUs 614.

Additionally or alternatively, the system 600 can include one or more wheel encoders 616. The wheel encoders 616 can generate encoder data descriptive of revolutions of wheels on the autonomous platform. For instance, the wheel encoders 616 can convey a number of revolutions (or partial revolutions) of wheels on the vehicle.

The system 600 can also communicate with one or more satellite navigation systems 618. The satellite navigation system(s) 618 can utilize one or more orbital satellites to provide geospatial positioning. Example satellite navigation systems 618 include global navigation satellite systems (GNSS) such as the Global Positioning System (GPS), GLONASS, Galileo, BeiDou, etc. Any suitable satellite navigation system can be employed in accordance with the present disclosure.

In some implementations, the satellite navigation system(s) 618 can provide a satellite doppler measurement for the pose estimation system 602. The satellite doppler measurement can be a measure of the doppler characteristics of the carrier phase signal received from a respective transmitting satellite. This doppler measurement can be directly proportional to the relative velocity between the transmitting satellite and a receiver (e.g., a GNSS receiver) onboard the vehicle. In some cases, the doppler measurement may be biased by a stochastically-wandering clock-rate error in the receiver. A receiver may have a respective bias that is applied to all measurements from that receiver. The bias may be relatively small (e.g., nanosecond-scale). This bias may be parametrized in the localization filter. For instance, the bias may be parameterized in units of meters-per-second by multiplying the receiver bias with the speed of light. Furthermore, this can counter round-off errors associated with comparing smaller (e.g., nanosecond-scale) values with other values in the localization filter having larger scales. The satellite navigation system(s) 618 can additionally provide an ephemeris from a respective satellite that can be used to determine the position and velocity of the respective satellite in an earth-centered, earth-fixed (ECEF) coordinate frame.

To fuse these measurements from the satellite navigation system(s), a clock rate bias state can be added for a respective receiver and an IMU from ECEF orientation state can be integrated with rigid body kinematics. These states can be used to predict the observed doppler value by determining the line-of-sight velocity to each satellite, compensating for the satellite's velocity according to the orbital parameters in the ephemeris, and adding the estimated clock-rate bias. A lightweight covariance gating procedure may be applied to these measurements to remove multipath effects and/or other unmodeled errors.

The system 600 can provide a trailer pose estimate 644 descriptive of a pose of a trailer coupled to an autonomous platform, such as a trailer of an autonomous truck. In some implementations, this functionality can be built directly into pose estimation system 602. Alternatively, in some implementations, the system 600 can include a trailer pose module 642 to produce the trailer pose estimate 644. The trailer pose module 642 can consume observations from a trailer observation module 640 configured to provide observations of the trailer. For instance, in some implementations, the trailer pose module 642 can fit a trailer plane to LIDAR point data extracted by the trailer observation module 640 to estimate the trailer pose estimates 644. For instance, when a trailer is captured in LIDAR point data, the point data corresponding to the trailer can generally resemble a plane positioned at a sidewall of the trailer. The trailer pose estimate 644 can be determined based on the orientation of the plane.

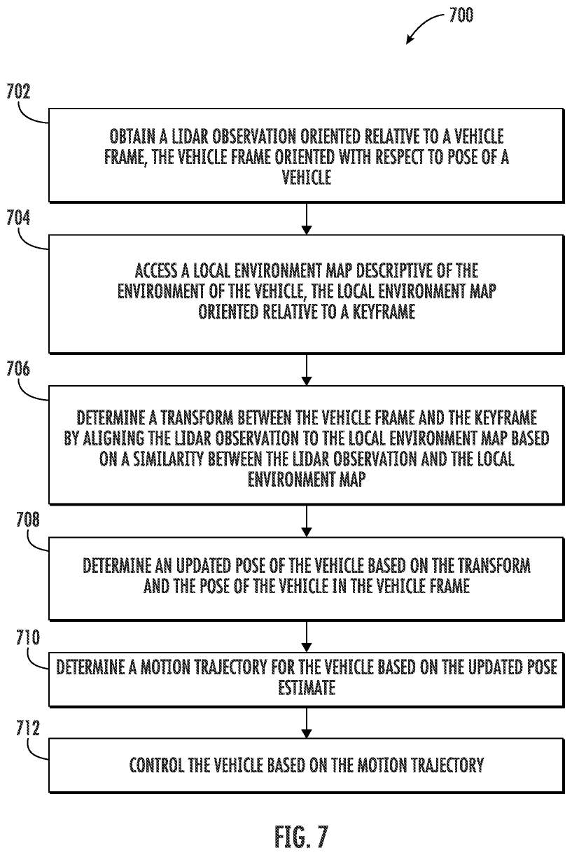

FIG. 7 is a flowchart of a method 700 for localizing an autonomous vehicle, according to some implementations of the present disclosure. One or more portion(s) of the method 700 can be implemented by one or more computing devices such as, for example, the computing devices described with reference to the other figures (e.g., autonomous platform 110, vehicle computing system 180, remote system(s) 160, a system of FIGS. 5, 6, 9, etc.). Each respective portion of the method 700 can be performed by any (or any combination) of one or more computing devices. Moreover, one or more portion(s) of the method 700 can be implemented on the hardware components of the device(s) described herein (e.g., as in FIGS. 1, 2, 5, 6, 9, etc.).

FIG. 7 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 7 is described with reference to elements/terms described with respect to other systems and figures for exemplary illustrated purposes and is not meant to be limiting. One or more portions of method 700 can be performed additionally, or alternatively, by other systems.

At 702, the method 700 can include obtaining a LIDAR observation. The LIDAR observation can be obtained from one or more LIDAR sensors. The LIDAR observation can be or can include a LIDAR point cloud. The LIDAR point cloud can include one or more LIDAR points.

As described herein, the LIDAR point(s) in the LIDAR point cloud can encode extensive data about an environment, such as intensity, classification of features, timestamps, and so on relative to a given coordinate frame associated with the LIDAR observation. The coordinate frame may be, for example, an X, Y, Z coordinate frame or other suitable coordinate frame. The LIDAR observation can be oriented relative to a vehicle frame, where the vehicle frame is oriented with respect to a pose of a vehicle (e.g., an autonomous vehicle) at a given time. For instance, the given time can be the time at which the LIDAR observation is captured.

The vehicle frame can be a coordinate frame related to the pose of the vehicle at the current time at which the LIDAR observation is captured. For instance, the LIDAR data points may be arranged relative to an origin centered on the pose of the vehicle. Additionally or alternatively, the coordinate frame of the LIDAR observation may be the vehicle frame itself. As one example, the LIDAR observation may be captured relative to the pose of a vehicle in a vehicle frame such that the LIDAR points are arranged based on a time of flight from the vehicle, as estimated by the vehicle's known pose. In some cases, the origin of the vehicle frame may not necessarily be the pose of the vehicle itself. However, the pose of the vehicle can be known in the vehicle frame.

At 704, the method 700 can include accessing a local environment map descriptive of the environment of the vehicle. The local environment map can be a regularly, progressively-updated map of the environment of the vehicle that is generated primarily (or entirely) from data captured on-board the vehicle. In some implementations, the local environment map is generated using, at least in part, data from one or more prior LIDAR observations. For instance, the local environment map may be generated (in real-time) from LIDAR observations aggregated during a current operational instance of a vehicle. For instance, the local environment map may be routinely updated based on one or more LIDAR observations captured during the current operational instance. As an example, new LIDAR observations may be fitted to the existing local environment map based on LIDAR data (e.g., LIDAR points) that are representative of data already included in the local environment map.

In some implementations, the local environment map may be a point cloud or, alternatively, some simplified geometric representation of the environment of the vehicle, such as a surfel map. Generally, the use of a simplified geometric representation can provide for improved aggregation of data across multiple LIDAR observations and provide for reduced computational requirements for reasoning about the environment of the vehicle.

The local environment map can be oriented relative to a keyframe. The vehicle may transition between multiple keyframes as it navigates its environment based on distance or time traveled by the vehicle. For instance, the keyframe may be relatively temporary in nature, and a keyframe may be periodically refreshed to negate the effects of drift and stale data over long trips, as described herein.

Furthermore, in some implementations, the local environment map can be defined with respect to a map frame. The map frame can be aligned with a keyframe, and rounded to a nearest unitary measurement (e.g., an integer), such as to cells of a tiled map grid. In addition, axes of any map frame may be commonly aligned. For instance, the axes of each map frame may be aligned with an original map frame determined upon vehicle startup, localization system reset, or other similar initial condition. In this manner, transformation of data between map frames can be performed with significant efficiency, as transformations can be performed by simple unitary (e.g., integer) arithmetic translations, without rotation operations. In some implementations, transformations between a keyframe and map frame can incorporate any necessary rotation operations and non-unitary translations.

Periodically shifting the coordinate system of the local environment map can ensure that the localization problem remains numerically well-conditioned, and facilitate modeling of measurements to relative, observable coordinate systems. Furthermore, translating the local environment map across keyframes can ensure that the current pose of the vehicle is generally near the origin of the local environment map, which can ensure relatively computationally simple transformations between keyframes over the duration of the vehicle's trip.

For instance, in one example implementation, an initial keyframe is established at a first time (e.g., corresponding to the start of a vehicle's travel), after the vehicle has collected some initial amount of data (e.g., relative to t0). The initial keyframe can be used to orient the local environment map for that vehicle's travel over some distance or time. Once the vehicle has traveled a certain distance or for a certain amount of time, the vehicle can establish a new keyframe (e.g., centered on or near the vehicle's current location). The distance or time traveled by the vehicle can be, for example, a fixed value such as about 50 meters, about 200 meters, about one minute, about five minutes, or other suitable values. Additionally or alternatively, the distance or time traveled by the vehicle may depend on parameters such as a velocity of the vehicle, an acquisition rate or resolution of sensors, a user- or operator-configurable setting, a memory available onboard the vehicle, or other suitable parameters.

Some or all of the data in the local environment map (generated at the first time) is then transformed to the new keyframe (e.g., based on the displacement between the original keyframe's origin and the new keyframe's origin) to generate a second local environment map, which is used in place of the original map. The second local map can be generated in real-time as the vehicle is traveling and is associated with a second time (e.g., later than the first time when the trip started).

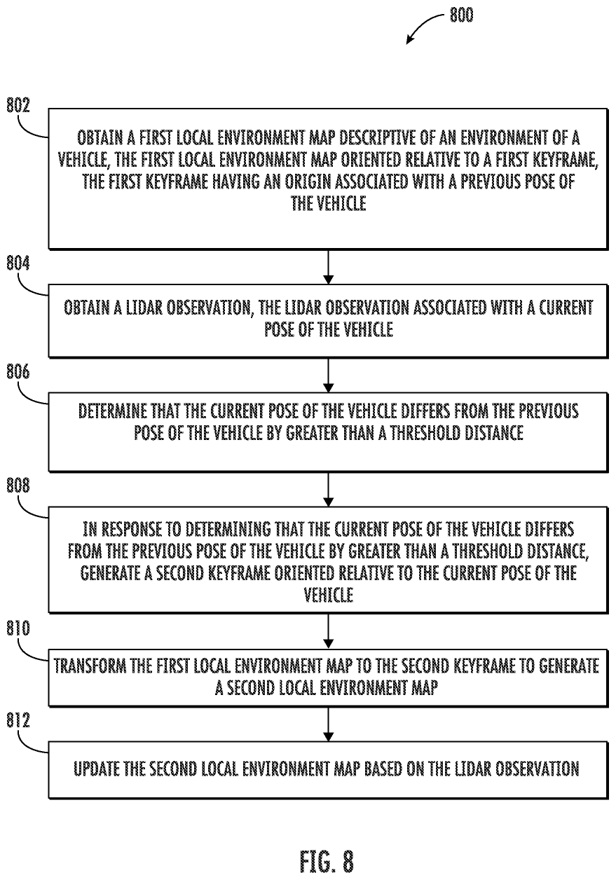

In some implementations, data older than some threshold or at a greater distance than some threshold is not to be translated to the second local environment map. This can provide for pruning data that is increasingly less relevant to the system. This process can repeat for the duration of the vehicle's trip. One example implementation of generating a local environment map is discussed in greater detail with respect to FIG. 8.

In some implementations, the local environment map can be a surfel map including a plurality of surfels. A surfel may be a disc defined by a position vector, a normal vector, and a radius. As described herein, the position vector can describe the location of the centroid of the disc (relative to a given coordinate frame, such as the keyframe). The normal vector can describe the orientation of the surfel in three-dimensional space. For instance, the normal vector can define the approximate surface normal at the centroid (e.g., the vector that is normal to the surface of the surfel, positioned at its centroid).

In some implementations, the resolution of the local environment map may decrease at distances farther from the position of the vehicle. For instance, in some implementations, the size of surfels in the local environment map may be smaller at positions close to the vehicle such that the immediate environment of the vehicle is represented with a high resolution. This can provide improved reasoning capabilities about the immediate environment of the vehicle. Additionally or alternatively, surfels farther from the vehicle may be larger and sparser such that comparatively less processing power is spent reasoning about surfels that do not represent portions of the environment near the vehicle.

At 706, the method 700 can include determining a transform between the vehicle frame and the keyframe by aligning the LIDAR observation to the local environment map based on a similarity between the LIDAR observation and the local environment map. The transform can be used to obtain the vehicle's position in the keyframe based on the alignment between the LIDAR observation and the local environment map. The local environment map can represent the environment's geometry with planar elements such as surfels. The transform between the two frames can therefore be found by minimizing the point-to-plane error between the LIDAR observation and the local environment map. As one example, this process may be mathematically represented by the following equation:

$$\frac{1}{2 N} {\sum }_{0 \leq i < N} ρ ( {( {( {T}_{vehicle}^{map} {p}_{i} - {c}_{m ( i )} )}^{T} {n}_{m ( i )} )}^{2} )$$

where pᵢ is a LIDAR point from a LIDAR point cloud with N total points, m(i) is the index of a given surfel matched to the point pᵢ, c and n are the centroid and normal, respectively, of surfel m(i), T_{vehicle}^{map} is the transformation between the vehicle frame and the keyframe, and ρ is the Huber loss function, which may be used to reduce sensitivity to outliers.

In some implementations, determining the transform between the vehicle frame and the keyframe includes aligning the LIDAR observation to the plurality of surfels of the local environment map to minimize an aggregate distance between the LIDAR observation and the plurality of surfels. The aggregate distance between the LIDAR observation and the plurality of surfels can be the sum of some or all distances between each point in the LIDAR observation and a closest centroid (or closest point) on a respective surfel of the plurality of surfels. Furthermore, in some implementations, minimizing the aggregate distance between the LIDAR observation and the plurality of surfels includes minimizing the aggregate distance between each LIDAR point in the LIDAR point cloud of the LIDAR observation and a corresponding surfel of the plurality of surfels. This distance computation may be based on the normal vector of the corresponding surfel. Additionally or alternatively, instead of considering aggregate distance, the system may instead minimize the average distance between a LIDAR point and corresponding surfel across all points and surfels. For instance, minimizing the aggregate distance between the LIDAR observation and the plurality of surfels can include minimizing an average distance between each LIDAR point in the LIDAR point cloud and the normal vector of a corresponding surfel of the plurality of surfels.

The vehicle can match LIDAR points to centroids of the surfels by transforming the points to the vehicle frame using the estimated transform from a previous iteration, then searching for a closest centroid. An initial guess of alignment can be computed using a previous estimate of the transform from a previous iteration, updated using a relative motion estimate from local pose. For instance, the relative motion estimate may be provided by another module onboard the vehicle, such as a global map, an inertial motion unit, a RADAR sensor, or any other suitable module. In some implementations, a dense grid is used to accelerate the closest point search while maintaining the algorithmic complexity of the matching task as a linear cost relative to the number of points and independent of the number of surfels. In some implementations, correspondences may be recomputed at each iteration. This can provide for an indirect rejection of outliers outside of the correspondence radius.

In some implementations, the system can minimize the robustified least squares cost. For instance, in some implementations, the system can employ the Levenberg-Marquardt algorithm to minimize the robusitified least squares cost. This robustifier can be approximated by iterative reweighting. The algorithm can be considered to converge when the system is unable to improve cost due to a prohibitively small step size, or based on a determination by a local quadratic model that the cost cannot be improved. In some implementations, aligning the LIDAR observation to the plurality of surfels is performed over a fixed number of iterations. The pose estimate of the vehicle may not be determined if the aggregate distance between the LIDAR observation and the plurality of surfels is not resolved over the fixed number of iterations. If the system does not find a local minimum (e.g., within a given number of iterations), the system may skip publishing a pose estimate for the iteration and begin a new iteration. In this manner, the system may be robust to minor outages in data availability.

In some implementations, during alignment of the LIDAR observation and local environment map, the system masks or otherwise omits regions of the LIDAR observation corresponding to moving objects, or “actors.” As described herein, these regions may not accurately represent static portions of the environment of the vehicle. For instance, determining the transform between the vehicle frame and the keyframe can include masking one or more actor regions in the LIDAR observation. The one or more actor regions can include data associated with a moving object. For instance, the actor region can include one or more LIDAR points associated with a moving object or actor. Masking the one or more actor regions can include omitting the one or more actor regions from the LIDAR observations when determining a transform between the vehicle frame and the keyframe by aligning the LIDAR observation to the local environment map. The actor region(s) (e.g., the masked regions) can be represented by bounding boxes supplied by other modules of the vehicle as described herein.

In some implementations, the system can further deduplicate actor regions from multiple sources. For instance, in some implementations, both a tracker system (e.g., a perception system) and a RADAR system may produce actor regions associated with the same object. Generally, the tracker system may produce a more accurate actor region. As such, if an actor region from a RADAR system and an actor region associated with a tracker system are co-located, it may be desirable to ignore the RADAR system's actor region, as the information may be more precisely captured in the perception system's actor region.

At 708, the method 700 can include determining a transformed pose estimate of the vehicle based on the transform and the pose of the vehicle in the vehicle frame. The transformed pose estimate can be respective to the keyframe, instead of the vehicle frame. Importantly, the transformed pose estimate can inform how much the vehicle has traveled from a previous estimate of the vehicle's pose with a high degree of precision. This precision may be attributable to the precision of LIDAR data and the high degree of recentness of the LIDAR data. In some implementations, determining the transformed pose estimate can include applying the transform to the pose of the vehicle in the vehicle frame to determine the transformed pose estimate of the vehicle respective to the keyframe. For instance, as described herein, the transform can define a translation, rotation, or other transformational actions that may be applied to any given point or region in the vehicle frame to obtain a representation of that point or region in the keyframe. Therefore, applying the transform to the points corresponding to the location of the vehicle in the vehicle frame (e.g., which is known from the LIDAR observation) can produce an estimate of the position of the vehicle in the keyframe. The transformed pose estimate can be an updated pose of the vehicle at the given time at which the vehicle frame is oriented with respect to the pose of the vehicle.

At 710, the method 700 can include determining a motion trajectory for the autonomous vehicle based on the transformed pose estimate. For instance, the transformed pose estimate can describe the position, orientation, etc. of the vehicle with respect to the vehicle's environment. Additionally or alternatively, other systems onboard the vehicle, such as a perception system, etc., can provide information about other objects in the environment of the autonomous vehicle, such as other vehicles, travelways (e.g., roads, paths, etc.), pedestrians, static objects, signage, and so on. Furthermore, in some implementations, the transformed pose estimate may be fused with information from other pose estimation modules (e.g., using a localization filter) to produce one or more pose estimates having a high degree of reliability. Using the transformed pose estimate (and/or pose estimates derived using the transformed pose estimate) and information about the environment of the autonomous vehicle, the vehicle computing system can determine a motion plan that allows the autonomous vehicle to navigate its environment.

At 712, an autonomous vehicle control system can control the vehicle based on the motion trajectory. The control system(s) can, for example, translate a motion trajectory into instructions for the appropriate platform control devices (e.g., acceleration control, brake control, steering control, etc.). By way of example, the control system(s) can translate a selected motion trajectory into instructions to adjust a steering component (e.g., a steering angle) by a certain number of degrees, apply a certain magnitude of braking force, increase/decrease speed, etc. In some implementations, the control system(s) can communicate with the platform control devices through communication channels including, for example, one or more data buses (e.g., controller area network (CAN), etc.), onboard diagnostics connectors (e.g., OBD-II, etc.), or a combination of wired or wireless communication links. The platform control devices can send or obtain data, messages, signals, etc. to or from the autonomy system(s) (or vice versa) through the communication channel(s).

FIG. 8 is a flowchart of a method 800 for localizing an autonomous vehicle, according to some implementations of the present disclosure. One or more portion(s) of the method 800 can be implemented by one or more computing devices such as, for example, the computing systems described with reference to the other figures (e.g., autonomous platform 110, vehicle computing system 180, remote system(s) 160, a system of FIGS. 5, 6, 9, etc.). Each respective portion of the method 800 can be performed by any (or any combination) of one or more computing devices. Moreover, one or more portion(s) of the method 800 can be implemented on the hardware components of the device(s) described herein (e.g., as in FIGS. 1, 2, 5, 6, 9, etc.), for example.

FIG. 8 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 8 is described with reference to elements/terms described with respect to other systems and figures for exemplary illustrated purposes and is not meant to be limiting. One or more portions of method 800 can be performed additionally, or alternatively, by other systems.

At 802, the method 800 can include obtaining a first local environment map descriptive of an environment of a vehicle. The first local environment map can be obtained by or from a LIDAR odometry module. The first local environment map can be a regularly, progressively-updated map of the environment of the vehicle that is generated primarily (or entirely) from data captured on-board the vehicle. In some implementations, the first local environment map is generated using, at least in part, data from one or more prior LIDAR observations. For instance, the first local environment map may be generated (in real-time) from LIDAR observations aggregated over a current operational instance of a vehicle. In some implementations, the first local environment map may be a point cloud or, alternatively, some simplified geometric representation of the environment of the vehicle, such as a surfel map. Generally, the use of a simplified geometric representation can provide for improved aggregation of data across multiple LIDAR observations and provide for reduced computational requirements for reasoning about the environment of the vehicle. The first local environment map can be oriented relative to a first keyframe. The first keyframe may be associated with a previous pose of the vehicle. For instance, an origin of the first keyframe may be associated with (e.g., centered on) a previous pose of the vehicle.

At 804, the method 800 can include obtaining a LIDAR observation. The LIDAR observation can be obtained from one or more LIDAR sensors. The LIDAR observation can be or can include a LIDAR point cloud with one or more LIDAR points, as described herein. The LIDAR observation can be associated with a current pose of the vehicle. For instance, in some implementations, the LIDAR observation can be oriented relative to a vehicle frame, where the vehicle frame is oriented with respect to the current pose of a vehicle. The vehicle frame can be a coordinate frame related to the pose of the vehicle at the current time at which the LIDAR observation is captured. For instance, the LIDAR data points may be arranged relative to an origin centered on the pose of the vehicle. Additionally or alternatively, the coordinate frame of the LIDAR observation may be the vehicle frame itself. As one example, the LIDAR observation may be captured relative to the pose of a vehicle in a vehicle frame such that the LIDAR points are arranged based on a time of flight from the vehicle, as estimated by the vehicle's known pose. In some cases, the origin of the vehicle frame may not necessarily be the pose of the vehicle itself. However, the pose of the vehicle can be known in the vehicle frame.

At 806, the method 800 can include determining that the current pose of the vehicle differs from the previous pose of the vehicle by greater than a threshold distance. For instance, this can include determining that the vehicle has traveled a distance greater than the threshold distance from the previous pose of the vehicle.

At 808, the method 800 can include, in response to determining that the current pose of the vehicle differs from the previous pose of the vehicle by greater than a threshold distance, generating a second keyframe oriented relative to the current pose of the vehicle. For instance, the second keyframe may be generated when the vehicle has traveled a sufficient distance from the origin of the first keyframe. In some implementations, the second keyframe may be generated after a threshold time has elapsed in addition to or alternatively to determining that the vehicle has traveled greater than a threshold distance.

Periodically shifting the coordinate system of the local environment map can provide for ensuring that the localization problem remains numerically well-conditioned, and facilitate modeling of measurements to relative, observable coordinate systems. Furthermore, translating the local environment map across keyframes can provide that the current pose of the vehicle is generally near the origin of the local environment map, which can ensure relatively computationally simple transformations between keyframes over the duration of the vehicle's trip.

At 810, the method 800 can include transforming the first local environment map to the second keyframe to generate a second local environment map. The second local environment map can include similar information to the first local environment map, but shifted to reflect the second keyframe. For instance, in some implementations, transforming the first local environment map to the second keyframe includes translating data in the first local environment map to the second keyframe to generate the second local environment map. For instance, the first keyframe and the second keyframe may be oriented relative to the same displacement from the same compass direction. This can provide for data to be transformed between the two keyframes by only translation, rather than translation and rotation. This, in turn, can provide for reduced computational costs when transforming data between keyframes.

In some implementations, transforming the first local environment map to the second keyframe can include determining a transformation between the first keyframe and the first map frame; determining a transformation between a first map frame associated with the first keyframe and the first local environment map and a second map frame associated with the second keyframe; and determining a transformation between the second map frame and the second keyframe. The first map frame and the second map frame can be defined relative to unitary coordinates (e.g., integer coordinates) and/or have axes that are co-oriented. For instance, the axes of the first map frame and the axes of the second map frame can each be oriented relative to an initial map frame of the vehicle, such as a map frame determined on startup of the vehicle or reset of the localization system, or another similar initial condition. In this manner, the transformation between the first map frame and the second map frame can include simple unitary translations (e.g., integer translations) without rotation operations. Transformations between the map frames and keyframes can include precise translations and rotation operations, if necessary.

In some implementations, transforming the first local environment map to the second keyframe includes pruning data greater than a cutoff distance from the current pose of the vehicle from the second local environment map. For instance, in some implementations, data older than some threshold or at a greater distance than some threshold may not be translated to the second local environment map to prune data that is increasingly less relevant to the system.

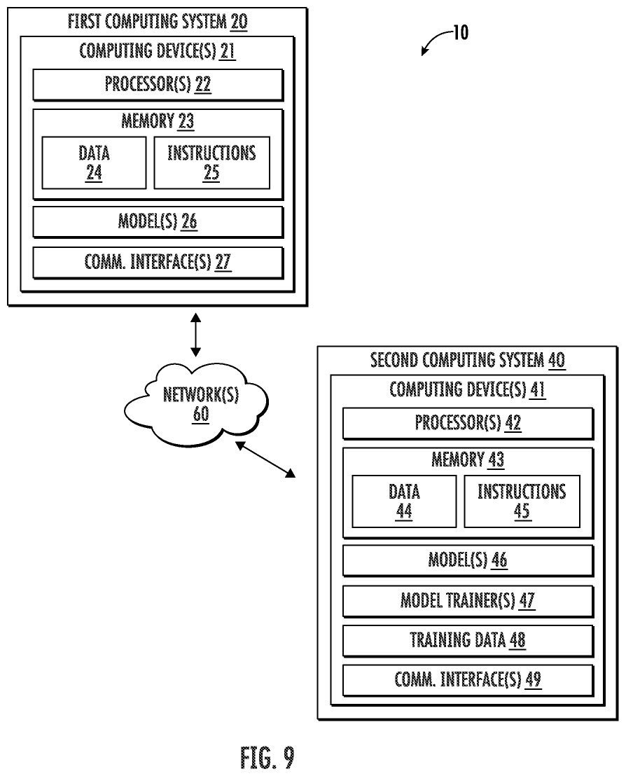

FIG. 9 is a block diagram of an example computing ecosystem 10 according to example implementations of the present disclosure. The example computing ecosystem 10 can include a first computing system 20 and a second computing system 40 that are communicatively coupled over one or more networks 60. In some implementations, the first computing system 20 or the second computing 40 can implement one or more of the systems, operations, or functionalities described herein for localizing an autonomous vehicle.

In some implementations, the first computing system 20 can be included in an autonomous platform and be utilized to perform the functions of an autonomous platform as described herein. For example, the first computing system 20 can be located onboard an autonomous vehicle and implement autonomy system(s) for autonomously operating the autonomous vehicle. In some implementations, the first computing system 20 can represent the entire onboard computing system or a portion thereof (e.g., the localization system 230, the perception system 240, the planning system 250, the control system 260, or a combination thereof, etc.). In other implementations, the first computing system 20 may not be located onboard an autonomous platform. The first computing system 20 can include one or more distinct physical computing devices 21.

The first computing system 20 (e.g., the computing device(s) 21 thereof) can include one or more processors 22 and a memory 23. The one or more processors 22 can be any suitable processing device (e.g., a processor core, a microprocessor, an ASIC, a FPGA, a controller, a microcontroller, etc.) and can be one processor or a plurality of processors that are operatively connected. The memory 23 can include one or more non-transitory computer-readable storage media, such as RAM, ROM, EEPROM, EPROM, one or more memory devices, flash memory devices, etc., and combinations thereof.

The memory 23 can store information that can be accessed by the one or more processors 22. For instance, the memory 23 (e.g., one or more non-transitory computer-readable storage media, memory devices, etc.) can store data 24 that can be obtained (e.g., received, accessed, written, manipulated, created, generated, stored, pulled, downloaded, etc.). The data 24 can include, for instance, sensor data, map data, data associated with autonomy functions (e.g., data associated with the perception, planning, or control functions), simulation data, or any data or information described herein. In some implementations, the first computing system 20 can obtain data from one or more memory device(s) that are remote from the first computing system 20.

The memory 23 can store computer-readable instructions 25 that can be executed by the one or more processors 22. The instructions 25 can be software written in any suitable programming language or can be implemented in hardware. Additionally, or alternatively, the instructions 25 can be executed in logically or virtually separate threads on the processor(s) 22.

For example, the memory 23 can store instructions 25 that are executable by one or more processors (e.g., by the one or more processors 22, by one or more other processors, etc.) to perform (e.g., with the computing device(s) 21, the first computing system 20, or other system(s) having processors executing the instructions) any of the operations, functions, or methods/processes (or portions thereof) described herein. For example, operations can include implementing system validation (e.g., as described herein).

In some implementations, the first computing system 20 can store or include one or more models 26. In some implementations, the models 26 can be or can otherwise include one or more machine-learned models (e.g., a machine-learned operational system, etc.). As examples, the models 26 can be or can otherwise include various machine-learned models such as, for example, regression networks, generative adversarial networks, neural networks (e.g., deep neural networks), support vector machines, decision trees, ensemble models, k-nearest neighbors models, Bayesian networks, or other types of models including linear models or non-linear models. Example neural networks include feed-forward neural networks, recurrent neural networks (e.g., long short-term memory recurrent neural networks), convolutional neural networks, or other forms of neural networks. For example, the first computing system 20 can include one or more models for implementing subsystems of the autonomy system(s) 200, including any of: the localization system 230, the perception system 240, the planning system 250, or the control system 260.

In some implementations, the first computing system 20 can obtain the one or more models 26 using communication interface(s) 27 to communicate with the second computing system 40 over the network(s) 60. For instance, the first computing system 20 can store the model(s) 26 (e.g., one or more machine-learned models) in the memory 23. The first computing system 20 can then use or otherwise implement the models 26 (e.g., by the processors 22). By way of example, the first computing system 20 can implement the model(s) 26 to localize an autonomous platform in an environment, perceive an autonomous platform's environment or objects therein, plan one or more future states of an autonomous platform for moving through an environment, control an autonomous platform for interacting with an environment, etc.

The second computing system 40 can include one or more computing devices 41. The second computing system 40 can include one or more processors 42 and a memory 43. The one or more processors 42 can be any suitable processing device (e.g., a processor core, a microprocessor, an ASIC, a FPGA, a controller, a microcontroller, etc.) and can be one processor or a plurality of processors that are operatively connected. The memory 43 can include one or more non-transitory computer-readable storage media, such as RAM, ROM, EEPROM, EPROM, one or more memory devices, flash memory devices, etc., and combinations thereof.

The memory 43 can store information that can be accessed by the one or more processors 42. For instance, the memory 43 (e.g., one or more non-transitory computer-readable storage media, memory devices, etc.) can store data 44 that can be obtained. The data 44 can include, for instance, sensor data, model parameters, map data, simulation data, simulated environmental scenes, simulated sensor data, data associated with vehicle trips/services, or any data or information described herein. In some implementations, the second computing system 40 can obtain data from one or more memory device(s) that are remote from the second computing system 40.

The memory 43 can also store computer-readable instructions 45 that can be executed by the one or more processors 42. The instructions 45 can be software written in any suitable programming language or can be implemented in hardware. Additionally, or alternatively, the instructions 45 can be executed in logically or virtually separate threads on the processor(s) 42.

For example, the memory 43 can store instructions 45 that are executable (e.g., by the one or more processors 42, by the one or more processors 22, by one or more other processors, etc.) to perform (e.g., with the computing device(s) 41, the second computing system 40, or other system(s) having processors for executing the instructions, such as computing device(s) 21 or the first computing system 20) any of the operations, functions, or methods/processes described herein. This can include, for example, the functionality of the autonomy system(s) 200 (e.g., localization, perception, planning, control, etc.) or other functionality associated with an autonomous platform (e.g., remote assistance, mapping, fleet management, trip/service assignment and matching, etc.). This can also include, for example, validating a machined-learned operational system.

In some implementations, the second computing system 40 can include one or more server computing devices. In the event that the second computing system 40 includes multiple server computing devices, such server computing devices can operate according to various computing architectures, including, for example, sequential computing architectures, parallel computing architectures, or some combination thereof.

Additionally, or alternatively to, the model(s) 26 at the first computing system 20, the second computing system 40 can include one or more models 46. As examples, the model(s) 46 can be or can otherwise include various machine-learned models (e.g., a machine-learned operational system, etc.) such as, for example, regression networks, generative adversarial networks, neural networks (e.g., deep neural networks), support vector machines, decision trees, ensemble models, k-nearest neighbors models, Bayesian networks, or other types of models including linear models or non-linear models. Example neural networks include feed-forward neural networks, recurrent neural networks (e.g., long short-term memory recurrent neural networks), convolutional neural networks, or other forms of neural networks. For example, the second computing system 40 can include one or more models of the autonomy system(s) 200.

In some implementations, the second computing system 40 or the first computing system 20 can train one or more machine-learned models of the model(s) 26 or the model(s) 46 through the use of one or more model trainers 47 and training data 48. The model trainer(s) 47 can train any one of the model(s) 26 or the model(s) 46 using one or more training or learning algorithms. One example training technique is backwards propagation of errors. In some implementations, the model trainer(s) 47 can perform supervised training techniques using labeled training data. In other implementations, the model trainer(s) 47 can perform unsupervised training techniques using unlabeled training data. In some implementations, the training data 48 can include simulated training data (e.g., training data obtained from simulated scenarios, inputs, configurations, environments, etc.). In some implementations, the second computing system 40 can implement simulations for obtaining the training data 48 or for implementing the model trainer(s) 47 for training or testing the model(s) 26 or the model(s) 46. By way of example, the model trainer(s) 47 can train one or more components of a machine-learned model for the autonomy system(s) 200 through unsupervised training techniques using an objective function (e.g., costs, rewards, heuristics, constraints, etc.). In some implementations, the model trainer(s) 47 can perform a number of generalization techniques to improve the generalization capability of the model(s) being trained. Generalization techniques include weight decays, dropouts, or other techniques.

For example, in some implementations, the second computing system 40 can generate training data 48 according to example aspects of the present disclosure. For instance, the second computing system 40 can generate training data 48. For instance, the second computing system 40 can implement methods according to example aspects of the present disclosure. The second computing system 40 can use the training data 48 to train model(s) 26. For example, in some implementations, the first computing system 20 can include a computing system onboard or otherwise associated with a real or simulated autonomous vehicle. In some implementations, model(s) 26 can include perception or machine vision model(s) configured for deployment onboard or in service of a real or simulated autonomous vehicle. In this manner, for instance, the second computing system 40 can provide a training pipeline for training model(s) 26.

The first computing system 20 and the second computing system 40 can each include communication interfaces 27 and 49, respectively. The communication interfaces 27, 49 can be used to communicate with each other or one or more other systems or devices, including systems or devices that are remotely located from the first computing system 20 or the second computing system 40. The communication interfaces 27, 49 can include any circuits, components, software, etc. for communicating with one or more networks (e.g., the network(s) 60). In some implementations, the communication interfaces 27, 49 can include, for example, one or more of a communications controller, receiver, transceiver, transmitter, port, conductors, software or hardware for communicating data.

The network(s) 60 can be any type of network or combination of networks that allows for communication between devices. In some implementations, the network(s) can include one or more of a local area network, wide area network, the Internet, secure network, cellular network, mesh network, peer-to-peer communication link or some combination thereof and can include any number of wired or wireless links. Communication over the network(s) 60 can be accomplished, for instance, through a network interface using any type of protocol, protection scheme, encoding, format, packaging, etc.

FIG. 10 illustrates one example computing ecosystem 10 that can be used to implement the present disclosure. Other systems can be used as well. For example, in some implementations, the first computing system 20 can include the model trainer(s) 47 and the training data 48. In such implementations, the model(s) 26, 46 can be both trained and used locally at the first computing system 20. As another example, in some implementations, the computing system 20 can not be connected to other computing systems. Additionally, components illustrated or discussed as being included in one of the computing systems 20 or 40 can instead be included in another one of the computing systems 20 or 40.

Computing tasks discussed herein as being performed at computing device(s) remote from the autonomous platform (e.g., autonomous vehicle) can instead be performed at the autonomous platform (e.g., via a vehicle computing system of the autonomous vehicle), or vice versa. Such configurations can be implemented without deviating from the scope of the present disclosure. The use of computer-based systems allows for a great variety of possible configurations, combinations, and divisions of tasks and functionality between and among components. Computer-implemented operations can be performed on a single component or across multiple components. Computer-implemented tasks or operations can be performed sequentially or in parallel. Data and instructions can be stored in a single memory device or across multiple memory devices.

Aspects of the disclosure have been described in terms of illustrative implementations thereof. Numerous other implementations, modifications, or variations within the scope and spirit of the appended claims can occur to persons of ordinary skill in the art from a review of this disclosure. Any and all features in the following claims can be combined or rearranged in any way possible. Accordingly, the scope of the present disclosure is by way of example rather than by way of limitation, and the subject disclosure does not preclude inclusion of such modifications, variations or additions to the present subject matter as would be readily apparent to one of ordinary skill in the art. Moreover, terms are described herein using lists of example elements joined by conjunctions such as “and,” “or,” “but,” etc. It should be understood that such conjunctions are provided for explanatory purposes only. Lists joined by a particular conjunction such as “or,” for example, can refer to “at least one of” or “any combination of” example elements listed therein, with “or” being understood as “and/or” unless otherwise indicated. Also, terms such as “based on” should be understood as “based at least in part on.”

Those of ordinary skill in the art, using the disclosures provided herein, will understand that the elements of any of the claims, operations, or processes discussed herein can be adapted, rearranged, expanded, omitted, combined, or modified in various ways without deviating from the scope of the present disclosure. Some of the claims are described with a letter reference to a claim element for exemplary illustrated purposes and is not meant to be limiting. The letter references do not imply a particular order of operations. For instance, letter identifiers such as (a), (b), (c), . . . , (i), (ii), (iii), . . . , etc. can be used to illustrate operations. Such identifiers are provided for the ease of the reader and do not denote a particular order of steps or operations. An operation illustrated by a list identifier of (a), (i), etc. can be performed before, after, or in parallel with another operation illustrated by a list identifier of (b), (ii), etc.

What is claimed is:

1. A computer-implemented method, comprising:
(a) obtaining a LIDAR observation oriented relative to a vehicle frame, wherein the vehicle frame is oriented with respect to a pose of a vehicle at a given time;
(b) accessing a local environment map descriptive of an environment of the vehicle, the local environment map oriented relative to a keyframe, the local environment map comprising a plurality of surfels;
wherein the local environment map is generated in real-time during a current operational instance of the vehicle based on one or more prior LIDAR observations captured during the current operational instance of the vehicle;
(c) determining a transform between the vehicle frame and the keyframe by aligning the LIDAR observation to the local environment map based on a similarity between the LIDAR observation and the local environment map; and
(d) determining an updated pose of the vehicle based on the transform and the pose of the vehicle in the vehicle frame at the given time.

2. The computer-implemented method of claim 1, wherein the updated pose of the vehicle is oriented relative to the keyframe.

3. The computer-implemented method of claim 1, wherein a surfel of the plurality of surfels comprises a disc, the disc defined by a position vector, a normal vector, and a radius.

4. The computer-implemented method of claim 1, wherein (c) comprises aligning the LIDAR observation to the plurality of surfels of the local environment map to minimize an aggregate distance between the LIDAR observation and the plurality of surfels.

5. The computer-implemented method of claim 4, wherein the LIDAR observation comprises a LIDAR point cloud, the LIDAR point cloud comprising a plurality of LIDAR points.

6. The computer-implemented method of claim 5, wherein minimizing the aggregate distance between the LIDAR observation and the plurality of surfels comprises minimizing the aggregate distance between each LIDAR point in the LIDAR point cloud of the LIDAR observation and a corresponding surfel of the plurality of surfels.

7. The computer-implemented method of claim 5, wherein minimizing the aggregate distance between the LIDAR observation and the plurality of surfels comprises minimizing an average distance between each LIDAR point in the LIDAR point cloud and a corresponding surfel of the plurality of surfels.

8. The computer-implemented method of claim 5, wherein aligning the LIDAR observation to the plurality of surfels is performed over a fixed number of iterations, and wherein the updated pose of the vehicle comprises a null output if the aggregate distance between the LIDAR observation and the plurality of surfels is not resolved over the fixed number of iterations.

9. The computer-implemented method of claim 1, further comprising masking one or more actor regions in the LIDAR observation, wherein the one or more actor regions comprise data associated with a moving object.

10. The computer-implemented method of claim 9, wherein masking the one or more actor regions comprises omitting the one or more actor regions from the LIDAR observation when determining the transform between the vehicle frame and the keyframe by aligning the LIDAR observation to the local environment map.

11. The computer-implemented method of claim 1, wherein (d) comprises applying the transform to the pose of the vehicle in the vehicle frame to determine the updated pose of the vehicle.

12. The computer-implemented method of claim 1, wherein the LIDAR observation is captured relative to the pose of the vehicle in the vehicle frame.

13. The computer-implemented method of claim 1, further comprising:
(e) determining a motion trajectory for the vehicle based on the updated pose of the vehicle; and
(f) controlling the vehicle based on the motion trajectory.

14. An autonomous vehicle (AV) control system, the AV control system comprising:
one or more processors; and
one or more non-transitory, computer-readable media storing instructions that cause the one or more processors to perform operations comprising:
(a) obtaining a LIDAR observation oriented relative to a vehicle frame, wherein the vehicle frame is oriented with respect to a pose of a vehicle at a given time;
(b) accessing a local environment map descriptive of an environment of the vehicle, the local environment map oriented relative to a keyframe, the local environment map comprising a plurality of surfels;
wherein the local environment map is generated in real-time during a current operational instance of the vehicle based on one or more prior LIDAR observations captured during the current operational instance of the vehicle;
(c) determining a transform between the vehicle frame and the keyframe by aligning the LIDAR observation to the local environment map based on a similarity between the LIDAR observation and the local environment map; and
(d) determining an updated pose of the vehicle based on the transform and the pose of the vehicle in the vehicle frame at the given time.

15. The AV control system of claim 14, wherein the updated pose of the vehicle comprises a transformed pose, the transformed pose oriented relative to the keyframe.

16. The AV control system of claim 14, wherein (c) comprises aligning the LIDAR observation to the plurality of surfels of the local environment map to minimize an aggregate distance between the LIDAR observation and the plurality of surfels.

17. The AV control system of claim 16, wherein the LIDAR observation comprises a LIDAR point cloud, the LIDAR point cloud comprising a plurality of LIDAR points.

18. The AV control system of claim 17, wherein minimizing the aggregate distance between the LIDAR observation and the plurality of surfels comprises minimizing the aggregate distance between each LIDAR point in the LIDAR point cloud of the LIDAR observation and a corresponding surfel of the plurality of surfels.

19. The AV control system of claim 17, wherein minimizing the aggregate distance between the LIDAR observation and the plurality of surfels comprises minimizing an average distance between each LIDAR point in the LIDAR point cloud and a corresponding surfel of the plurality of surfels.

20. An autonomous vehicle, comprising:
one or more processors; and
one or more non-transitory, computer-readable media storing instructions that cause the one or more processors to perform operations comprising:
(a) obtaining a LIDAR observation oriented relative to a vehicle frame, wherein the vehicle frame is oriented with respect to a pose of a vehicle at a given time;
(b) accessing a local environment map descriptive of an environment of the vehicle, the local environment map oriented relative to a keyframe, the local environment map comprising a plurality of surfels;
wherein the local environment map is generated in real-time during a current operational instance of the vehicle based on one or more prior LIDAR observations captured during the current operational instance of the vehicle;
(c) determining a transform between the vehicle frame and the keyframe by aligning the LIDAR observation to the local environment map based on a similarity between the LIDAR observation and the local environment map; and
(d) determining an updated pose of the vehicle based on the transform and the pose of the vehicle in the vehicle frame at the given time.
